(19) United States
(12) Patent Application Publication
(10) Pub. No.: US 2016/0012364 A1
(43) Pub. Date: Jan. 14, 2016

(54) COMMITMENT SOCIAL NETWORK SYSTEM AND METHOD

(71) Applicant: Alexandre da Silva Filgueiras, Sao Paulo (BR)

(72) Inventor: Alexandre da Silva Filgueiras, Sao Paulo (BR)

(21) Appl. No.: 14/479,394

(22) Filed: Sep. 8, 2014

Related U.S. Application Data
(60) Provisional application No. 62/022,360, filed on Jul. 9, 2014.

(51) Int. Cl. G06Q 10/06; G06Q 10/10; G06Q 50/00

(52) U.S. Cl. CPC G06Q 10/06311; G06Q 50/01; G06Q 10/109

(57) ABSTRACT

The present invention relates generally to social networks implemented and managed through a communication network. Specifically, a Commitment Social Network is described where participants can request, accept, and evaluate commitments with each other. Optionally, commitment moderators and commitment watchers may also participate in the commitment life cycle. The Commitment Social Network allows participants to manage and track Commitments to achieve better Commitment performance and balance in their lives.

### CROSS-REFERENCE TO RELATED APPLICATION

The present application claims priority from provisional application 62/022,360 filed on Jul. 9, 2014 and entitled Commitment Social Network System and Method, the content of which is hereby incorporated by reference into this application.

### FIELD OF THE INVENTION

The present invention generally relates to Social Networking. Specifically, embodiments of the present invention disclose a system and method for creating, and managing a Commitment Social Network allowing users to establish formal Commitments with each other, follow up on those commitments, and give and receive performance evaluations relating to those commitments.

### BACKGROUND OF THE INVENTION

Currently, there are available several solutions for social networks, which may allow their members to establish relations involving several items, such as text messages, images, audios, videos, URLs, invitations, advices, questions & answers, and much more in a very well established implementation and usage, but they do not meet the basis to establish formal Commitments among their members.

In order to provide the establishment of formal Commitments among their members, the current solutions lack several necessary topics, such as: Commitment roles definitions and responsibilities, roles assignments; Commitment statement elaboration and verification criteria; Commitment unique Identification codes (IDs); Commitment members formal certification of authenticity; full Commitment life cycle phases control: proposal, analysis, acceptance, performance, evaluation of Commitment performer and goal(s) achievement(s), and finally Commitment performer feedback for his/her continuous improvement.

Furthermore, it would be desirable to have a mechanism, inside the available social networks, that support several types of Commitment management actions, such as Commitment dynamic navigations structure, commitment visualization reports, commitment events management, and administration of members relationship categories and types.

Therefore, there currently exists a need to have a formal Commitment Social Network system and method, that enables its members to establish Commitments among each other with appropriate management control and support, to provide a continuous Commitment behavior culture improvement among these members.

### SUMMARY

Accordingly, it is an object of the present invention to provide a commitment social network wherein users can request and accept commitments and evaluate and be evaluated on performance of commitments. Commitment members can also track their commitment performance through reports and thereby improve their commitment performance in various social relationships

According to an embodiment of the present invention, a system for managing interactions in a network comprises: a processor and a memory; a communication network interface; commitments control module; wherein the processor and memory, the communication network interface, and the commitments control module are operably connected and are configured such that the commitments control module is enabled to: receive profile information of one or more members; receive a proposal to perform a commitment; receive an acceptance to perform the commitment; provide one or more members with information regarding the current status of the commitment; receive a commitment done indication; receive an evaluation of the commitment to produce an evaluated commitment; and provide one or more members with information about the evaluated commitment.

According to an embodiment of the present invention, the system is further configured to receive comments on the commitment.

According to an embodiment of the present invention, the system is further configured to receive instructions relating to moderating conflicts, and/or, changing a commitment's deadline.

According to an embodiment of the present invention, the commitment is associated with a deadline defined by a commitment performance period and/or a commitment evaluation period.

According to an embodiment of the present invention, the system is further configured to verify that the commitment meets certain criteria by using a commitment template comprising: a commitment role assignment field; a field for a commitment statement; a commitment's deadline field; and a measurement field for defining a quantity or quality.

According to an embodiment of the present invention, the commitment template may be configured with additional fields in order to represent different commitment kinds.

According to an embodiment of the present invention, the system further comprises an Access Control Module configured to verify the authenticity of members.

According to an embodiment of the present invention, the system further comprises a Report Generator Module configured to use commitment data to generate at least one of: A commitment radar report; A commitment balance report; A statistical report of commitment evaluations; Commitment Trend lines; and A network report showing one or more layers of commitment connections between members.

According to an embodiment of the present invention, the system is further configured to provide a commitment tree navigator wherein a user-definable hierarchy of commitment information categories defines the general structure of the commitment tree.

According to an embodiment of the present invention, the commitment may be assigned a unique identifier.

According to an embodiment of the present invention, relationships between members may be categorized into two or more relationship categories.

According to an embodiment of the present invention, the relationship categories comprise: personal, family, friends, neighborhood, school, work, business, club, sports, fitness, health, church, religion, politics, society, and/or a user-defined category.

According to an embodiment of the present invention, the relationship categories comprise: relationships with peers, relationships with superiors, and/or relationships with subordinates.

According to an embodiment of the present invention, relationships within a relationship category may be further defined by relationship types related to the roles of one or more members in the relationship.

According to an embodiment of the present invention, the roles comprise: child, parent, brother, sister, friend, boyfriend, girlfriend, husband, wife, classmate, student, professor, patient, doctor, peers, coworker, boss, employee, employer, subordinate, superior, supplier, client, and/or a user-defined role.

According to an embodiment of the present invention, the commitments may depend upon and/or be linked to one or more other commitments.

According to an embodiment of the present invention, a method of managing interactions in a network comprising the steps of: receiving profile information of one or more members; receiving a proposal to perform a commitment; receiving an acceptance to perform the commitment; providing one or more members with information regarding the current status of the commitment; receiving a commitment done indication; receiving an evaluation of the commitment to produce an evaluated commitment; and provide one or more members with information about the evaluated commitment.

According to an embodiment of the present invention, the method further comprises the step of receiving comments on the commitment.

According to an embodiment of the present invention, the method further comprises the step of receiving instructions relating to moderating conflicts, and/or, changing a commitment's deadline.

According to an embodiment of the present invention, the commitment is associated with a deadline defined by a commitment performance period and/or a commitment evaluation period.

According to an embodiment of the present invention, the method further comprises the step of verifying that the commitment meets certain criteria by using a template comprising: a commitment role assignment field; a field for a commitment statement; a commitment's deadline field; and a measurement field for defining a quantity or quality.

According to an embodiment of the present invention, the commitment template may be configured with additional fields in order to represent different commitment kinds.

According to an embodiment of the present invention, the method further comprises the step of verifying the authenticity of members.

According to an embodiment of the present invention, the method further comprises the step of using commitment data to generate at least one of: a commitment radar report; a commitment balance report; a statistical report of commitment evaluations; commitment Trend lines; and a network report showing one or more layers of commitment connections between members.

According to an embodiment of the present invention, the method further comprises the step of providing a commitment tree navigator wherein a user-definable hierarchy of commitment information categories defines the general structure of the commitment tree.

According to an embodiment of the present invention, the method further comprises the step of assigning the commitment a unique identifier.

According to an embodiment of the present invention, the method further comprises the step of categorizing relationships into two or more relationship categories.

According to an embodiment of the present invention, the relationship categories comprise: personal, family, friends, neighborhood, school, work, business, club, sports, fitness, health, church, religion, politics, society, and/or a user-defined category.

According to an embodiment of the present invention, the relationship categories comprise: relationships with peers, relationships with superiors, and/or relationships with subordinates.

According to an embodiment of the present invention, the method further comprises the step of defining relationships within a relationship category by relationship types related to the roles of one or more members in the relationship.

According to an embodiment of the present invention, the roles comprise: child, parent, brother, sister, friend, boyfriend, girlfriend, husband, wife, classmate, student, professor, patient, doctor, peers, coworker, boss, employee, employer, subordinate, superior, supplier, client, and/or a user-defined role.

According to an embodiment of the present invention, the commitments may depend upon and/or be linked to one or more other commitments.

Embodiments of the present invention advantageously fill the aforementioned necessities by providing a Commitment Social Network (CSN) system comprising: a plurality of members interface apparatus; a network communication infrastructure; a Commitment Social Network Controller (CSNC), including members and Commitments databases, plus Commitment control modules.

In one embodiment of the present invention, the CSN Members may play several roles: a Commitment Requestor, a Commitment Performer, and a Commitment Evaluator. Additionally they may also play optional roles: a Commitment Watcher and a Commitment Moderator.

In one embodiment of the present invention, the Commitments may be established and controlled by a method comprising phases and steps:

Phase A—Commitment proposal elaboration and roles assignments: The Commitment Requestor elaborates a Commitment proposal, whose formalism for its statement may be verified based on the so called “S.M.A.R.T. criteria” (S-Specific, M-Measurable, A-Assignable, R-Realistic, T-Time-Based); The Commitment Requestor assigns the roles of Commitment Performer, Commitment Evaluator(s), and optionally Commitment Moderator(s) and/or Commitment Watcher(s) to the respective involved CSN members; Additionally, the Commitment Requestor may also select several Commitment control attributes to support management controls; Moreover, the CSNC may check Commitment Requestor authenticity of origin through his/her digital certificate, check S.M.A.R.T. criteria fulfilment, and assigns a unique ID to the Commitment.

Phase B—Commitment proposal analysis and acceptance: The Commitment Performer analyzes a Certified Commitment proposal and decides to accept or reject to perform it; The Commitment Evaluator(s) analyze(s) a Certified Commitment proposal and decides to accept or reject to evaluate it; In case of any rejection, another retry may be done after necessary changes.

Phase C—Commitment Performer performance and goal(s) achievement evaluation: The Commitment Performer performs the necessary task(s) to achieve an accepted Commitment statement goal(s) on pre-defined period, and indicates to the CSNC when it is considered done plus any additional relevant information; The CSNC awaits the evaluation period start or the reception of commitment done indication from the Commitment Performer, and sends a reminder to the Commitment Evaluator(s) for evaluation; The Commitment Evaluator(s) may constantly check if the commitment statement has been broken or wait for the reception of evaluation reminder from CSNC in order to evaluate Commitment Performer performance and goal(s) achievement by a pre-defined scale of ratings, and additionally provide(s) feedback comments to the Commitment Performer; The CSNC compiles all acquired data regarding the Commitment, which may be stored in the members and Commitment databases, and sends the results to all involved member(s) for analysis and potential improvements of the member(s) behavior in future Commitments.

Moreover, the involved CSN members may follow the Commitment life cycle evolution and add comments (which may contain attached elements, such as texts, images, audio, videos, URLs, e-mails, files, or even another Commitments) to other involved members(s).

Furthermore, the Commitment Watcher(s) may manifest through the comments reactions, such as incentives, suggestions, helps, alerts, opinions, and/or any similar actions normally done by an audience.

The optional Commitment Moderator(s) has/have the power to moderate eventual issues and/or conflicts making the necessary actions, such as postpone Commitment due dates, adding comments and recommendations, or even, in an extreme case, cancelling the Commitment.

In another embodiment, the CSN system may generate several types of Commitments navigation controls, such as dynamic structured trees, tables, charts, and graphs. The CSN may generate also several Commitments visualization reports, such as Radar, Balance, Social Graphs, Trend lines, and Statistics regarding their members Commitments and their respective quantity and evaluation quality ratings.

These navigations controls and visualization reports, which may be built based on the data stored in the members and Commitment databases, may be organized by several Commitment control attributes, such as Commitment kinds, Commitments priority, Commitments complexity, members relationship categories, members relationship types, groups/sub-groups of member(s), assigned roles to members, Commitment links to other Commitments and their respective link type, and selected periods in order to be used by the CSN members for better Commitments management, Commitments benchmarking, and Commitments relationship balancing among the members.

The present invention and its features and advantages described in this summary, now will be detailed more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1A is a system overview illustrating an overall environment suitable for a Commitment Social Network (CSN), in accordance with an embodiment of the invention;

FIG. 1B is an example of a block diagram of a member interface apparatus device, in accordance with an embodiment of the invention;

FIG. 1C is an example of a block diagram of a Commitment Social Network Controller (CSNC) which may be used in the system or standalone, in accordance with an embodiment of the invention;

FIG. 1D is an example of databases which may be used by CSNC, in accordance with an embodiment of the invention;

FIG. 1E is an example of Control Modules which may be used by CSNC, in accordance with an embodiment of the invention;

FIG. 2 is a content chart with CSN roles, in accordance with an embodiment of the invention;

FIG. 3 is a content chart with CSN roles and a Commitment Social Network Controller (CSNC), and their main respective actions related to a Commitment, in accordance with an embodiment of the invention;

FIG. 4 is a sequence interaction flowchart with a Commitment life cycle evolution overview, in accordance with an embodiment of the invention;

FIG. 5 is a sequence interaction flowchart with Commitment life cycle, describing the interactions among Commitment main roles and suggested main phases (A, B, and C), in accordance with an embodiment of the invention;

FIG. 6A is a flowchart of the function of the CSNC during Commitment life cycle Phase A: Commitment proposal creation and roles assignment (in more detail), in accordance with an embodiment of the invention;

FIG. 6B is a flowchart of the function of the CSNC during Commitment life cycle Phase B: Commitment proposal analysis and acceptance (in more detail), in accordance with an embodiment of the invention;

FIG. 6C is a flowchart of the function of the CSNC during Commitment life cycle Phase C: Commitment Performer performance and goal(s) achievement evaluation (in more detail), in accordance with an embodiment of the invention;

FIG. 7 is a sequence interaction flowchart with an additional security level, in order to assure Commitment members authenticity and Commitment contents encryption protection by digital certification prior art technology, in accordance with an embodiment of the invention;

FIG. 8 is a table with main Commitment role assignment cases, in accordance with an embodiment of the invention;

FIG. 9 is a table with main Commitment role assignment cases, including short Commitment statement examples, in accordance with an embodiment of the invention;

FIG. 10 is an example screenshot illustrating a CSN login interface, in accordance with an embodiment of the invention;

FIG. 11 is an example screenshot illustrating a CSN main user interface, in accordance with an embodiment of the invention;

FIG. 12 is an example screenshot illustrating how to add a member as a contact, or to invite one to become a new member of the CSN, in accordance with an embodiment of the invention;

FIG. 13 is an example screenshot illustrating how to add a relationship among members including its category, type and possible roles in a relationship, in accordance with an embodiment of the invention;

FIG. 14 is an example screenshot illustrating how to add a group and/or invite a member to join a group of member(s), in accordance with an embodiment of the invention;

FIG. 15 is an example screenshot illustrating a summary view with info about members relationship structured by relationship category, relationship type, and selected allowed roles from a member perspective, in accordance with an embodiment of the invention;

FIG. 16 is an example screenshot illustrating a summary with info about groups and sub-groups and their respective members, in accordance with an embodiment of the invention;

FIG. 17 is an example screenshot illustrating a new Commitment proposal elaboration with main Commitment control attributes selection, roles assignment, and an environment for a Commitment formal statement elaboration and compilation, in accordance with an embodiment of the invention;

FIG. 18A is an example screenshot illustrating a dynamic Commitment tree structure navigator which may be built based on a Commitment control attributes sequence selector according to member (Alice) preferences, in accordance with an embodiment of the invention;

FIG. 18B is an example screenshot illustrating a dynamic Commitment tree structure navigator which may be built based on a Commitment control attributes sequence selector according to member (Bob) preferences, in accordance with an embodiment of the invention;

FIG. 18C is an example screenshot illustrating a dynamic Commitment tree structure navigator which may be built based on a Commitment control attributes sequence selector according to member (Eric) preferences, in accordance with an embodiment of the invention;

FIG. 18D is an example screenshot illustrating a dynamic Commitment tree structure navigator which may be built based on a Commitment control attributes sequence selector according to member (Alice) other preferences, in accordance with an embodiment of the invention;

FIG. 19A is an example screenshot illustrating a Commitment radar report, which may be built dynamically based on different attributes selected by a member, in this specific example “relationship category”, in accordance with an embodiment of the invention;

FIG. 19B is an example screenshot illustrating another Commitment radar report, which may be built dynamically based on different attributes selected by a member, in this specific example “relationship type”, in accordance with an embodiment of the invention;

FIG. 20 is an example screenshot illustrating a Commitment balance report, which may be built dynamically based on different attributes selected by a member, in this specific example “relationship category”, in accordance with an embodiment of the invention;

FIG. 21 is an example screenshot illustrating a Commitment trend line based report, which may be built dynamically based on different attributes and metrics selected by a member, in accordance with an embodiment of the invention;

FIG. 22 is a screenshot example illustrating a Commitment statistic based report, which may be built dynamically based on selected Commitment control attributes scope, in accordance with an embodiment of the invention;

FIG. 23 is an example screenshot illustrating a Commitment social network graph among a member in focus and other related members, which may be built dynamically based on selected attributes and deep levels, in accordance with an embodiment of the invention;

FIG. 24 is a screenshot example illustrating a member profile info and sharing configuration options, in accordance with an embodiment of the invention;

FIG. 25A is a screenshot example illustrating a configuration environment where a member may add/edit Commitment kinds and its respective templates, in accordance with an embodiment of the invention;

FIG. 25B is a screenshot example with another Commitment kind template, in accordance with an embodiment of the invention;

FIG. 26 is a screenshot example illustrating a configuration environment where a member may add/edit members relationship categories and/or relationship types, in accordance with an embodiment of the invention;

FIG. 27 is a screenshot example illustrating a configuration environment to manage a member digital certificate(s), in accordance with an embodiment of the invention;

FIG. 28 is a screenshot example illustrating an environment to visualize and manage recent Commitment events, in accordance with an embodiment of the invention;

FIG. 29 is a screenshot example illustrating an environment to visualize and manage recent Commitment events in more details, such as Commitment ID, versions, attributes, roles assignments, and actions, in accordance with an embodiment of the invention;

FIG. 30 is a screenshot example illustrating an environment to visualize recent Commitment events in a time schedule progress view, in accordance with an embodiment of the invention;

FIG. 31 is a screenshot example illustrating an environment to visualize and manage next coming Commitment events, in accordance with an embodiment of the invention;

FIG. 32 is a screenshot example illustrating an environment to visualize and manage next coming Commitment events in more details, such as Commitment ID, versions, attributes, roles assignments, and actions, in accordance with an embodiment of the invention;

FIG. 33 is a screenshot example illustrating an environment to visualize next coming Commitment events in a time schedule progress view, in accordance with an embodiment of the invention;

FIG. 34 is a screenshot example illustrating an environment to evaluate a Commitment, in accordance with an embodiment of the invention;

FIG. 35 is a screenshot example illustrating an environment to visualize and manage history Commitment events, in accordance with an embodiment of the invention;

FIG. 36 is a screenshot example illustrating an environment to search CSN Commitment elements, in accordance with an embodiment of the invention;

### DETAILED DESCRIPTION

In reference to the accompanying drawings, it is highlighted that the particulars shown are by way of example and for purposes of illustrative discussion of the preferred embodiments of the present invention only, and are presented in order to provide what is believed to be the most useful and readily understood description of the principles and conceptual aspects of the invention. From the description and drawings it will be apparent to those skilled in the art how the several forms of the present invention may be embodied in practice. Throughout the drawings, identical or similar reference numbers designate identical or similar elements. Throughout the specification, terms expressed in the singular form may refer to the plural and vice versa.

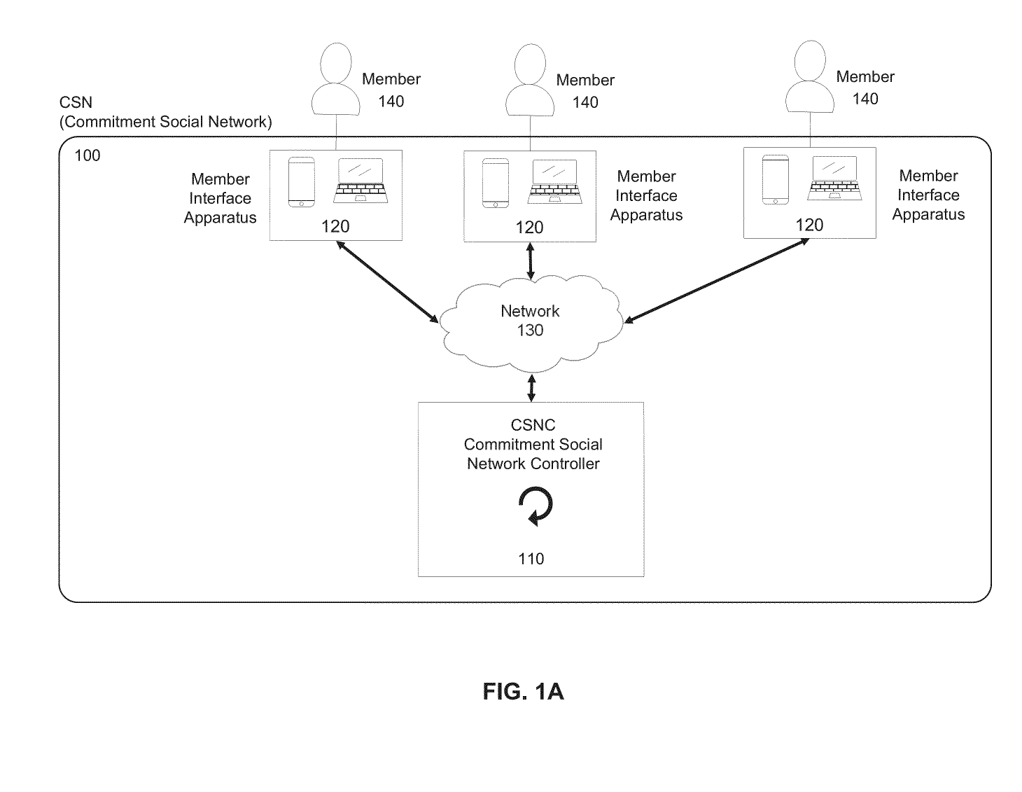

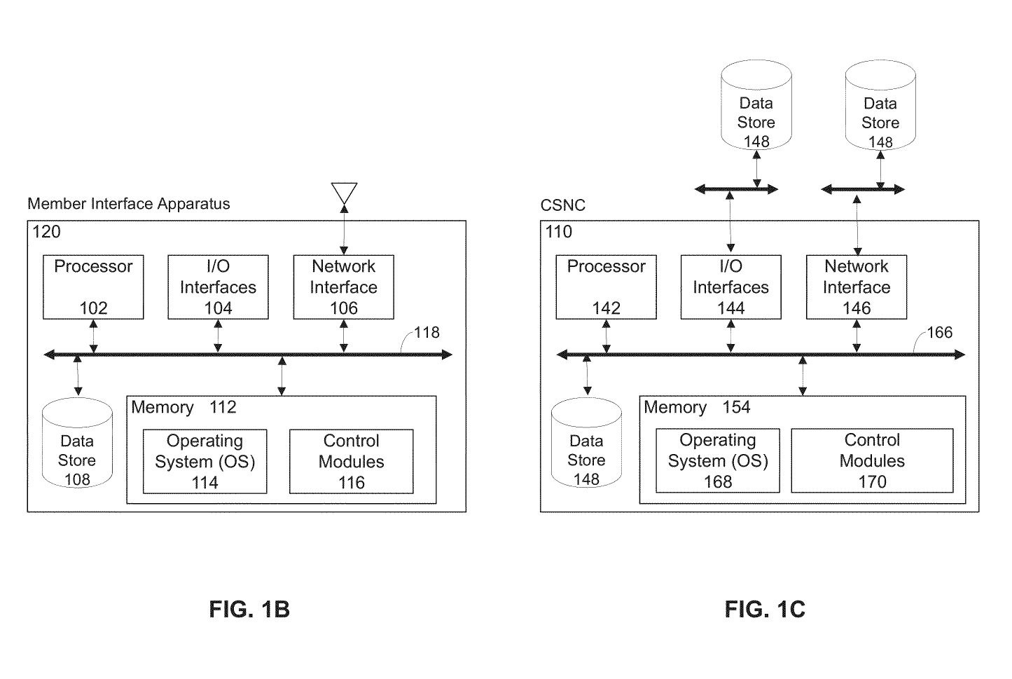

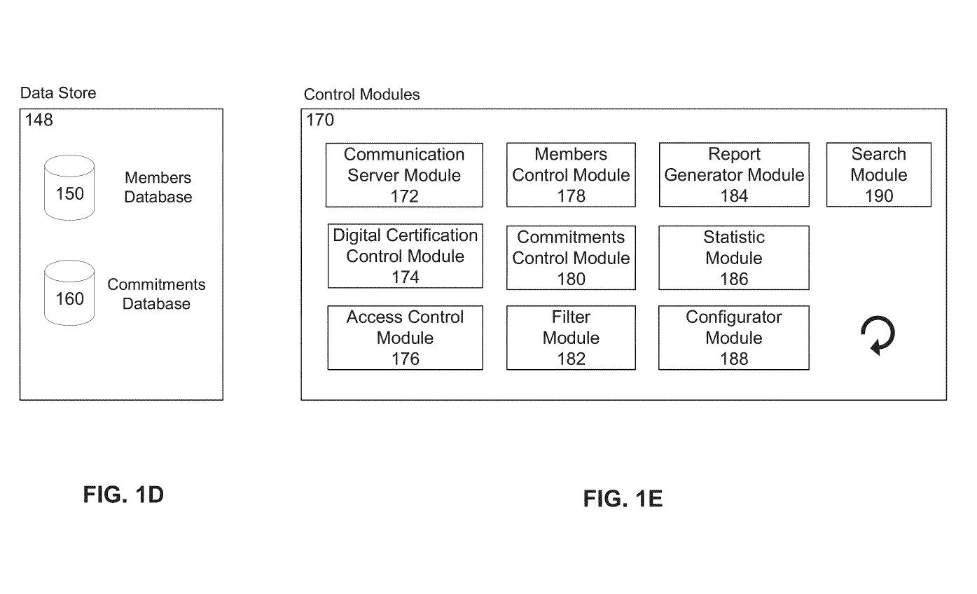

FIG. 1A is a system overview illustrating an overall environment suitable for a Commitment Social Network (CSN), in accordance with an embodiment of the invention;

In one embodiment of the present invention, a CSN system 100 may comprise a Commitment Social Network Controller (CSNC) 110, a communication network 130, and one or more member interface apparatus 120, which provide the necessary users interface environment to enable CSN members 140 to interact with the CSNC to establish, track, verify, and evaluate commitments with each other.

In one embodiment of the present invention, the CSNC 110 is mainly responsible for managing communication flow among the CSN members 140, storing data regarding CSN members 140 and their Commitments, providing several Commitment management tools, generating Commitment related reports, and/or similar tasks necessary to establish Commitments among CSN members 140.

In one embodiment of the present invention, the communication network 130 may be the internet, an intranet, a local area network, a phone network, a TV network, or a combination of them, using wired or wireless standard communication technologies, such as DSL, Ethernet, Wi-Fi, WiMAX, 3G, 4G, or any similar. Additionally the communication network 130 may use standard protocols, such as TCP/IP, UDP, HTTP, HTTPS, SMTP, FTP, or any similar in order to provide the communication data exchange. In addition, the communication network 130 may use standard formats to represent the exchanged data, such as HTML, XML, or any similar. Moreover in order to provide higher security levels the data exchanged may be encrypted using standard technologies, such as TSL, SSL, or any similar.

In one embodiment of the present invention, the member interface apparatus 120 may be any computerized device able to exchange data through the communication network 130 and to provide the necessary user inputs and outputs interface interactions, such as smartphones, tablets, netbooks, notebooks, desktops, smart TVs, and/or wearable computers.

In one embodiment of the present invention, the CSN member 140 may be an individual, organization, an entity representative, a member group or sub-group, an artificial intelligence, or anyone who participates in the CSN 100.

FIG. 1B is an example of a block diagram of a member interface apparatus device, in accordance with an embodiment of the invention;

In one embodiment of the present invention, a member interface apparatus 120 may be a digital device that, in terms of hardware architecture, generally includes a processor 102, input/output (I/O) interfaces 104, a Network Interface 106, a data store 108, and a memory 112. It should be appreciated by those of ordinary skill in the art that FIG. 1B depicts the member interface apparatus 120 in an oversimplified manner, and a practical embodiment may include additional components and suitably configured processing logic to support known or conventional operating features that are not described in detail herein. The components (102, 104, 106, 108, and 112) are communicatively coupled via a local interface 118. The local interface 118 can be, for example but not limited to, one or more buses or other wired or wireless connections, as is known in the art. The local interface 118 can have additional elements, which are omitted for simplicity, such as controllers, buffers (caches), drivers, repeaters, and receivers, among many others, to enable communication. Further, the local interface 118 may include address, control, and/or data connections to enable appropriate communications among the aforementioned components.

The processor 102 is a hardware device for executing software instructions. The processor 102 can be any custom made or commercially available processor, a central processing unit (CPU), an auxiliary processor among several processors associated with the member interface apparatus 120, a semiconductor-based microprocessor (in the form of a microchip or chip set), or generally any device for executing software instructions. When the member interface apparatus 120 is in operation, the processor 102 is configured to execute software stored within the memory 112, to communicate data to and from the memory 112, and to generally control operations of the member interface apparatus 120 pursuant to the software instructions. In an exemplary embodiment, the processor 102 may include a mobile optimized processor such as optimized for power consumption and mobile applications. The I/O interfaces 104 can be used to receive user input from and/or for providing system output. User input can be provided via, for example, a keypad, a touch screen, a scroll ball, buttons, bar code scanner, voice instructions, and the like. System output can be provided via a display device, such as a liquid crystal display (LCD), touch screen, and the like. The I/O interfaces 104 can also include, for example, a serial port, a parallel port, a small computer system interface (SCSI), an infrared (IR) interface, a radio frequency (RF) interface, a universal serial bus (USB) interface, and the like. The I/O interfaces 104 can include a graphical user interface (GUI) that enables a user to interact with the member interface apparatus 120. Additionally, the I/O interfaces 104 may further include an imaging device, i.e. camera, video camera, etc.

The network interface 106 may be used to enable the member interface apparatus 120 to communicate on a network, such as the Internet, a wide area network (WAN), a local area network (LAN), and the like, etc. The network interface 106 may include, for example, an Ethernet card or adapter (e.g., 10 BaseT, Fast Ethernet, Gigabit Ethernet, 10 GbE), a wireless local area network (WLAN) card or adapter (e.g., 802.11a/b/g/n/ac), IrDA (infrared) and/or a radio. The network interface 106 may include address, control, and/or data connections to enable appropriate communications on the network. A radio enables wireless communication to an external access device or network. Any number of suitable wireless data communication protocols, techniques, or methodologies can be supported by the radio, including, without limitation: RF; Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 108 may be used to store data. The data store 108 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 may incorporate electronic, magnetic, optical, and/or other types of storage media.

The memory 112 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 112 may incorporate electronic, magnetic, optical, and/or other types of storage media. Note that the memory 112 may have a distributed architecture, where various components are situated remotely from one another, but can be accessed by the processor 102. The software in memory 112 can include one or more software programs, each of which includes an ordered listing of executable instructions for implementing logical functions. In the example of FIG. 1B, the software in the memory 112 includes a suitable operating system (O/S) 114 and Control Modules 116. The operating system 114 essentially controls the execution of other computer programs, and provides scheduling, input-output control, file and data management, memory management, and communication control and related services. The Control Modules 116 may include various applications, add-ons, etc. configured to provide end user functionality with the member interface apparatus 120. For example, exemplary Control Modules 116 may include, but not limited to social networking applications, a web browser, streaming media applications, mapping and location applications, electronic mail applications, financial applications, and the like.

FIG. 1C is an example of a block diagram of a Commitment Social Network Controller (CSNC) which may be used in the system or standalone, in accordance with an embodiment of the invention;

In one embodiment of the present invention, a Commitment Social Network Controller (CSNC) 110 may be used in the CSN system 100, in other systems, or standalone. The CSNC 110 may be a digital computer that, in terms of hardware architecture, generally includes a processor 142, input/output (I/O) interfaces 144, a network interface 146, a data store 148, and memory 154. It should be appreciated by those of ordinary skill in the art that FIG. 1C depicts the CSNC 110 in an oversimplified manner, and a practical embodiment may include additional components and suitably configured processing logic to support known or conventional operating features that are not described in detail herein. The components (142, 144, 146, 148, 154, 156, 168, 170) are communicatively coupled via a local interface 166. The local interface 166 may be, for example but not limited to, one or more buses or other wired or wireless connections, as is known in the art. The local interface 166 may have additional elements, which are omitted for simplicity, such as controllers, buffers (caches), drivers, repeaters, and receivers, among many others, to enable communications. Further, the local interface 166 may include address, control, and/or data connections to enable appropriate communications among the aforementioned components.

The processor 142 is a hardware device for executing software instructions. The processor 142 may be any custom made or commercially available processor, a central processing unit (CPU), an auxiliary processor among several processors associated with the CSNC 110, a semiconductor-based microprocessor (in the form of a microchip or chip set), or generally any device for executing software instructions. When the CSNC 110 is in operation, the processor 142 is configured to execute software stored within the memory 154, to communicate data to and from the memory 154, and to generally control operations of the CSNC 110 pursuant to the software instructions. The I/O interfaces 144 may be used to receive user input from and/or for providing system output to one or more devices or components. User input may be provided via, for example, a keyboard, touch pad, and/or a mouse. System output may be provided via a display device and a printer (not shown). I/O interfaces 144 may include, for example, a serial port, a parallel port, a small computer system interface (SCSI), a serial ATA (SATA), a fiber channel, Infiniband, iSCSI, a PCI Express interface (PCI-x), an infrared (IR) interface, a radio frequency (RF) interface, and/or a universal serial bus (USB) interface.

The network interface 146 may be used to enable the CSNC 110 to communicate on a network, such as the Internet, an intranet, a wide area network (WAN), a local area network (LAN), and the like, etc. The network interface 146 may include, for example, an Ethernet card or adapter (e.g., 10 BaseT, Fast Ethernet, Gigabit Ethernet, 10 GbE), a wireless local area network (WLAN) card or adapter (e.g., 802.11a/b/g/n/ac), IrDA (infrared), or a radio to enable wireless communication to an external access device or network. Any number of suitable wireless data communication protocols, techniques, or methodologies can be supported by the radio, including, without limitation: RF; Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The network interface 146 may include address, control, and/or data connections to enable appropriate communications on the network. A data store 148 may be used to store data. The data store 148 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 148 may incorporate electronic, magnetic, optical, and/or other types of storage media. In one example, the data store 148 may be located internal to the CSNC 110 such as, for example, an internal hard drive connected to the local interface 166 in the CSNC 110. Additionally in another embodiment, the data store 148 may be located external to the CSNC 110 such as, for example, an external hard drive connected to the I/O interfaces 144 (e.g., SCSI or USB connection). In a further embodiment, the data store 148 may be connected to the CSNC 110 through a network, such as, for example, a network attached file server.

The memory 154 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 154 may incorporate electronic, magnetic, optical, and/or other types of storage media. Note that the memory 154 may have a distributed architecture, where various components are situated remotely from one another, but can be accessed by the processor 142. The software in memory 154 may include one or more software programs, each of which includes an ordered listing of executable instructions for implementing logical functions. The software in the memory 154 includes a suitable operating system (O/S) 168 and one or more Control Modules 170 which may be organized by control modules. The operating system 168 essentially controls the execution of other computer programs, such as the one or more Control Modules 170, and provides scheduling, input-output control, file and data management, memory management, and communication control and related services. The one or more Control Modules 170 may be configured to implement the various controls, processes, algorithms, methods, techniques, etc. described herein.

FIG. 1D is an example of databases which may be used by CSNC, in accordance with an embodiment of the invention.

In one embodiment of the present invention, a data store 148 may comprise a members database 150 and a database of Commitments 160.

In one embodiment of the present invention, the members database 150 stores data information regarding the CSN members 140, such as members profiles, members photos, members contacts, groups of members, members relationships, members roles, members digital certification info, and any data information related to the CSN members 140.

In one embodiment of the present invention, the database of Commitments 160 stores data information regarding CSN Commitments 300, such as Commitment IDs, Commitment involved members, Commitment control attributes, Commitment statements, Commitment acceptance status, Commitment done status, Commitment life cycle states, Commitment performance periods, Commitment evaluation periods, Commitment evaluation results (including ratings and feedbacks), Commitment comments, Commitment events, Commitment versions, Commitments attached elements, Commitment links to other Commitments and their respective link type, and any data information related to the CSN Commitments 300. One of ordinary skill in the art will appreciate that these databases could be combined, further divided, or distributed over a network structure without departing from the spirit and scope of the present invention.

In another embodiment, the members database 150 and/or database of Commitments 160 may be organized in just one or even in several separated databases with extra data integrated for other controls.

FIG. 1E is an example of Control Modules which may be used by CSNC, in accordance with an embodiment of the invention;

In one embodiment of the present invention, the Control Modules 170 may comprise several control modules such as a Communication server module 172, an access control module 176, a digital certification control Module 174, a members control module 178, a commitment control module 180, a filter module 182, a report generator module 184, a statistic module 186, a configurator module 188, and a search module 190.

In other embodiments, the Control Modules 170 may have additional modules for other controls, such as application downloads, APIs, load balancers, failover servers, extra security, and more, which are not described here in order to not obscure the main concepts of the invention.

In one embodiment of the present invention, the Communication server module 172 may be responsible to establish a communication channel from the CSNC 110 to the members interface apparatus 120 through the communication network 130, which can be done by a standard web server, or any network-related technology able to exchange information.

In one embodiment of the present invention, the digital certification control module 174 may be responsible to control the members digital certificates in order to provide higher level of security to the CSN members 140, by the certification of authenticity of CSN members 140 through third party Certifications Authority (CA). Additionally, the digital certification control module 174 may also add extra security levels by encrypting the Commitment data contents using public and private key encryption. One of ordinary skill in the art would appreciate that there are a variety of ways in which encryption and certification can be achieved and using an alternate method of either certification or encryption or using none at all would not be a departure from the spirit and scope of the present invention.

In another embodiment, the digital certification control module 174 may also verify and manage digital certification locally rather than using a third party Certification Authority.

In one embodiment of the present invention, the access control module 176 may be responsible for handling member login, member invitations, member access to information stored in the CSNC databases, individual member authorizations, or any other access control related tasks in order to keep a safe security environment for all CSN members 140. Additionally, the access control module 176 may use the members' digital certificates for login.

In one embodiment of the present invention, the members control module 178 may be responsible for handling tasks related to read and/or write to the members database 150, such as contacts additions, relationships addition (including category, type and possible roles in the relationship), member group creation, sub-groups of groups creation, members addition to these groups, visualization and navigation of members contacts by their relationships and groups.

In one embodiment of the present invention, the commitment control module 180 may be responsible for handling tasks related to read and/or write to the database of Commitments 160, such as creation of a new Commitment (including the Commitment control attributes, Commitment role assignment, Commitment formal statements, and its optional attached elements), management of a Commitment life cycle, visualization and navigation of Commitments by structured dynamic trees, or any similar tasks.

In one embodiment of the present invention, the filter module 182 may be responsible for providing the necessary scope selection from the members database 150 and/or the database of Commitments 160, in order to provide to the CSN members 140 better management of their commitment activities, navigation, analysis, or any other task which may be improved by a scope selection through several different control attributes filtering. Additionally the filter module 182 may also support dynamic navigation tree structures, which may be built by selected control attributes sequence in accordance to the CSN members 140 individual preferences.

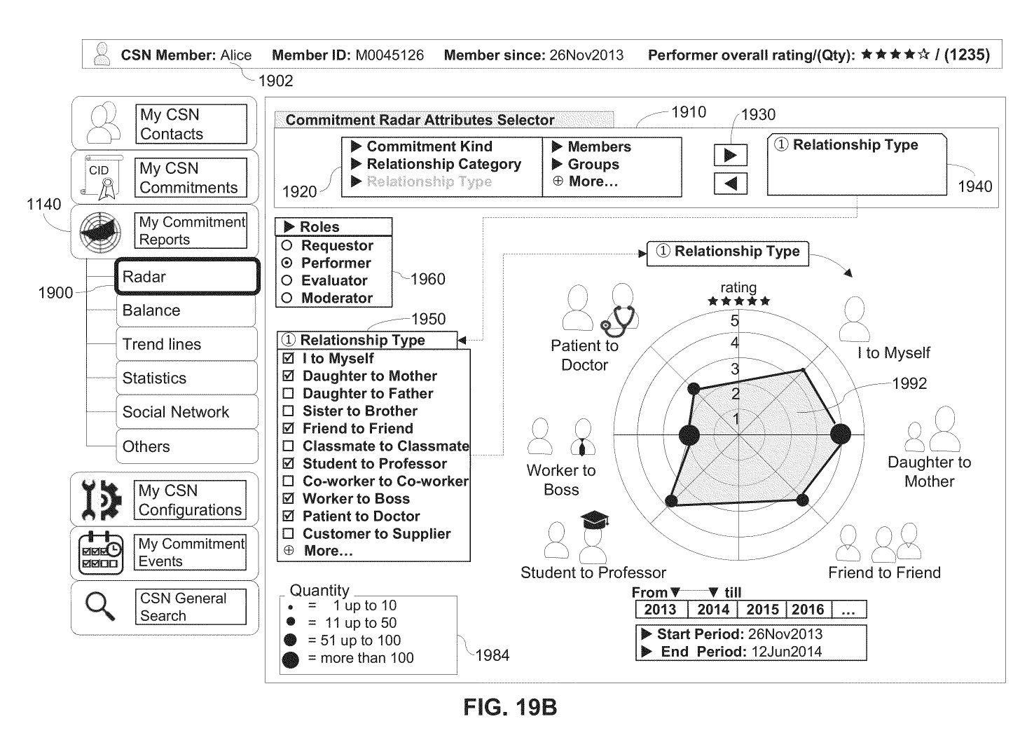

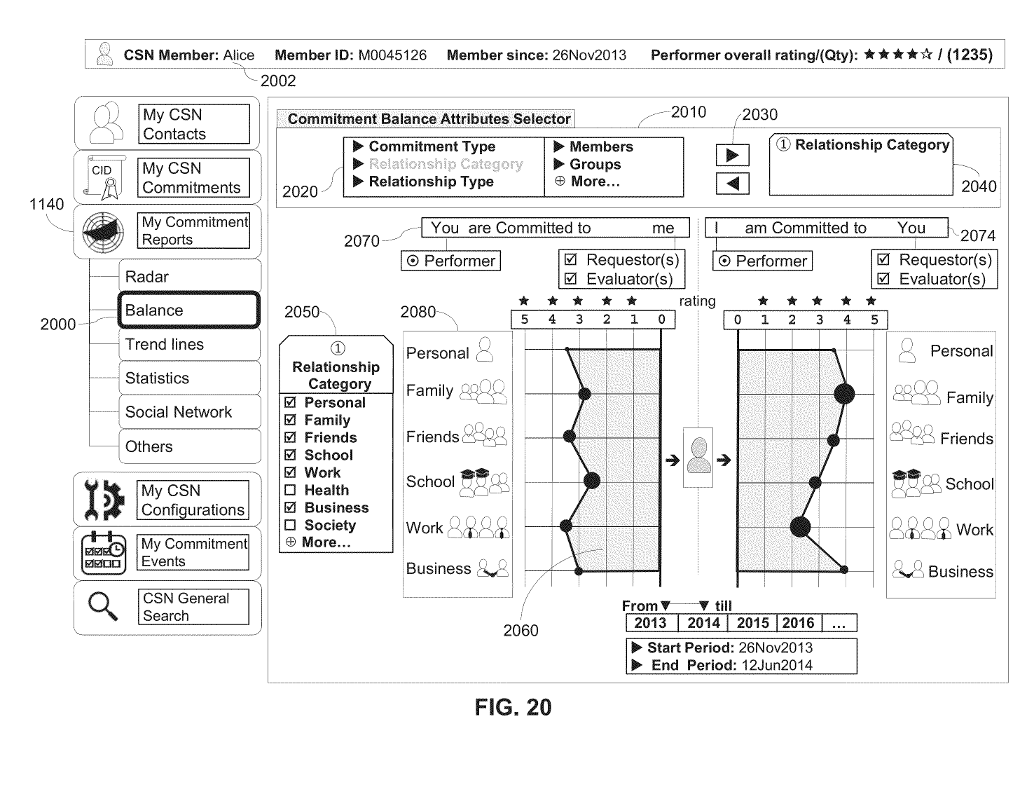

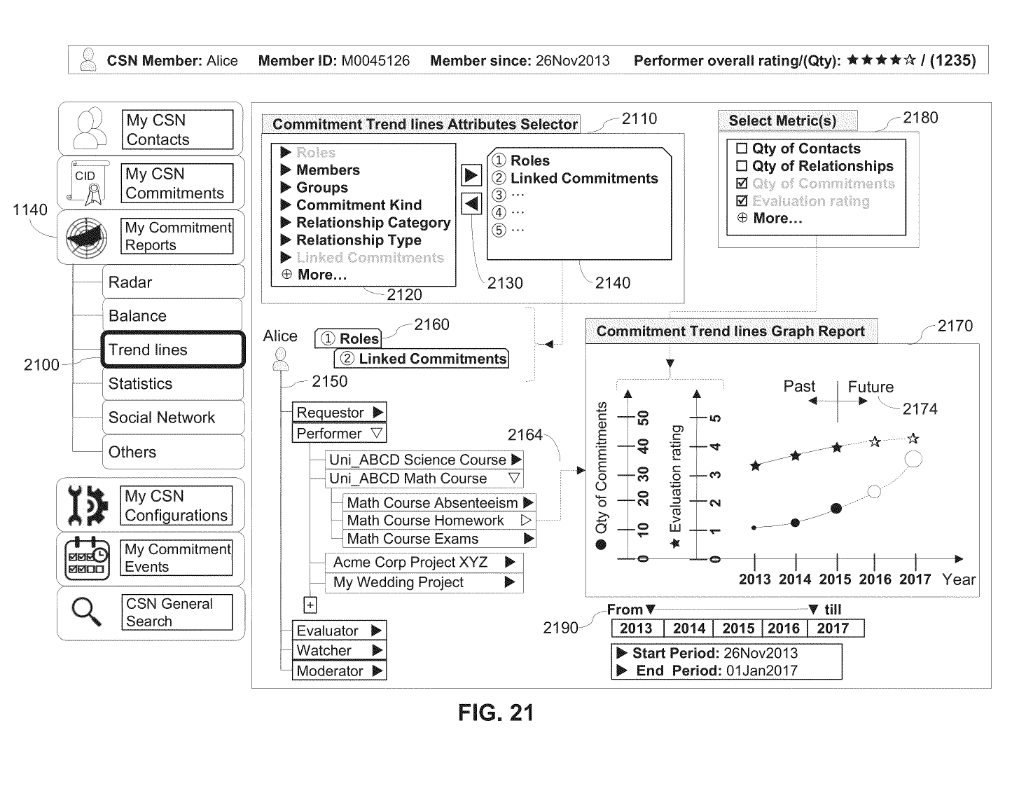

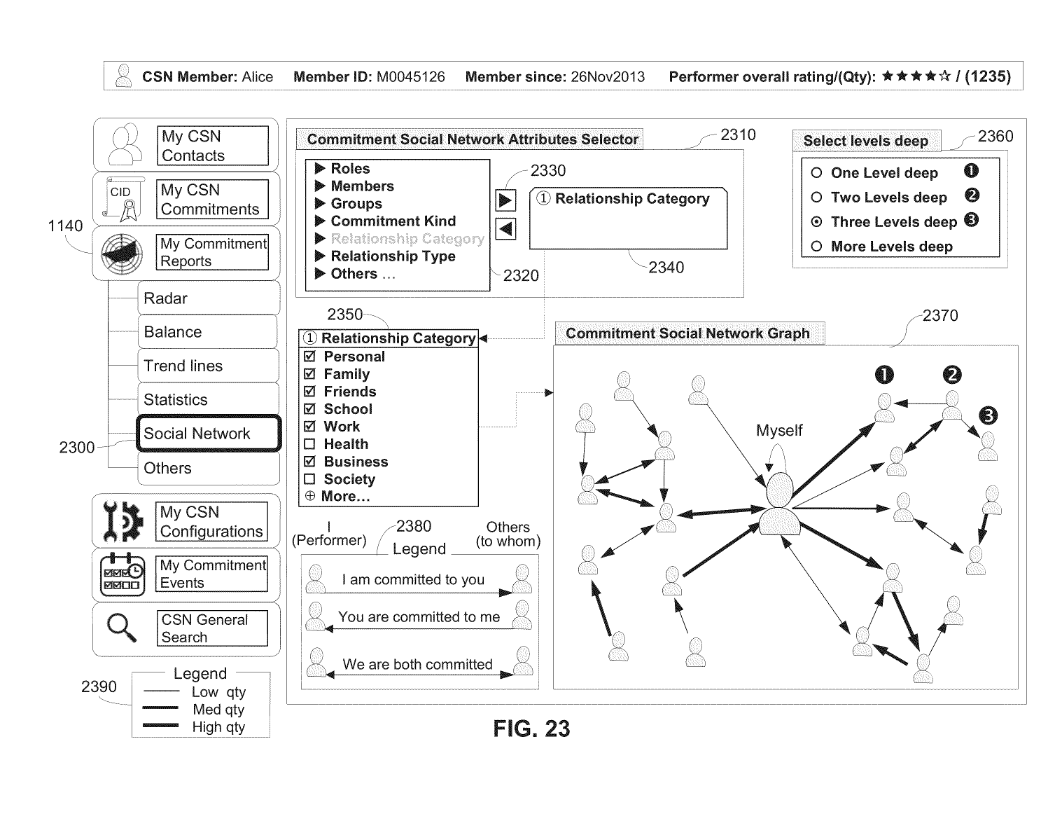

In one embodiment of the present invention, the report generator module 184 may be responsible for generating several types of reports, such as Commitment radar reports (see FIG. 19 1900), Commitment balance reports (see FIG. 20 2000), Commitment trend line reports (see FIG. 21 2100), Commitment social network graph reports (see FIG. 23 2300), and/or any other Commitment report which can be driven by the data contents available inside the members database 150 and/or the database of Commitments 160.

In one embodiment of the present invention, the statistic module 186 may be responsible for generating statistics info regarding a specific scope selected by the CSN member 140, such as quantity of Commitments per each evaluation rating, count of Commitments, minimum rating, maximum rating, average rating, standard deviation, trend lines, and/or any kind of useful criteria for analysis of a member and his/her Commitments performance.

In one embodiment of the present invention, the configurator module 188 may be responsible for configuring the CSN members 140 profiles, such as nickname, photo, gender, e-mail, address, birthday, scholarship, company, and other info regarding their profile. Additionally the configurator module 188 manages the Commitment kinds and creation and editing of their respective templates, as well as the member relationship categories and relationship types. Moreover the configurator module 188 may also manage the CSN members 140 digital certificates including monitoring their status and importing the available certificates from third parties entities.

In another embodiment, the configurator module 188 may also configure other configuration items, such as communication settings, members preferences, specific configurations of member interface apparatus 120, screen sizes, menus layout and/or any type of configuration to adjust the individual needs of the CSN members 140.

In one embodiment of the present invention, the search module 190 may be responsible for providing search functions in order to find Commitment items inside the CSN system 100. In order to facilitate the search process, the filter module 182 may also be used to refine the scope of the search by selection of several Commitment control attributes, such as roles, members, groups, Commitment IDs, Commitment kind, Commitment priority, Commitment complexity, relationship category, relationship type, periods, and/or any other characteristic which may be used to restrict the search scope. Additionally, the search module 190 may further refine the scope of the search by selecting the target item that has been searched, such as Commitment title, Commitment statement, Commitment comments, Commitment feedback, attached elements, members name, group name, and/or any similar items.

In other embodiments, the control modules may be implemented in a distributed strategy, such as in other CSNCs, running as software modules on one or more general purpose server machines, or incorporated into the member interface apparatus 120, however for purposes of explanation and not limitation, embodiments will be described with the control modules incorporated into the CSNC.

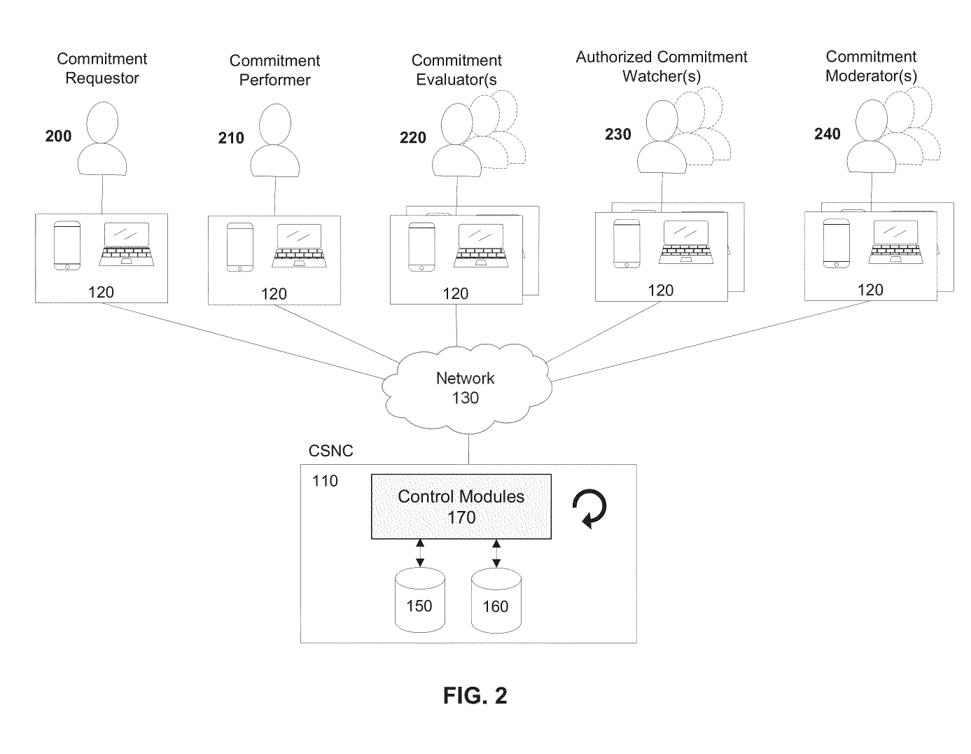

FIG. 2 is a content chart with CSN roles, in accordance with an embodiment of the invention.

In one embodiment of the present invention, the CSN main Commitment roles may include: a Commitment Requestor 200, a Commitment Performer 210, and a Commitment Evaluator 220. Furthermore, other roles may be optionally included, such as an Commitment Watcher 230 and a Commitment Moderator 240. Some roles may be assigned to more than one CSN member 140 in a commitment, such as Commitment Evaluator 220, Commitment Watcher 230, and Commitment Moderator 240. Additionally, the same CSN member 140 may be assigned more than one role in a Commitment.

The users (200, 210, 220, 230, 240) interact with the CSNC 110 over some kind of network which was described previously.

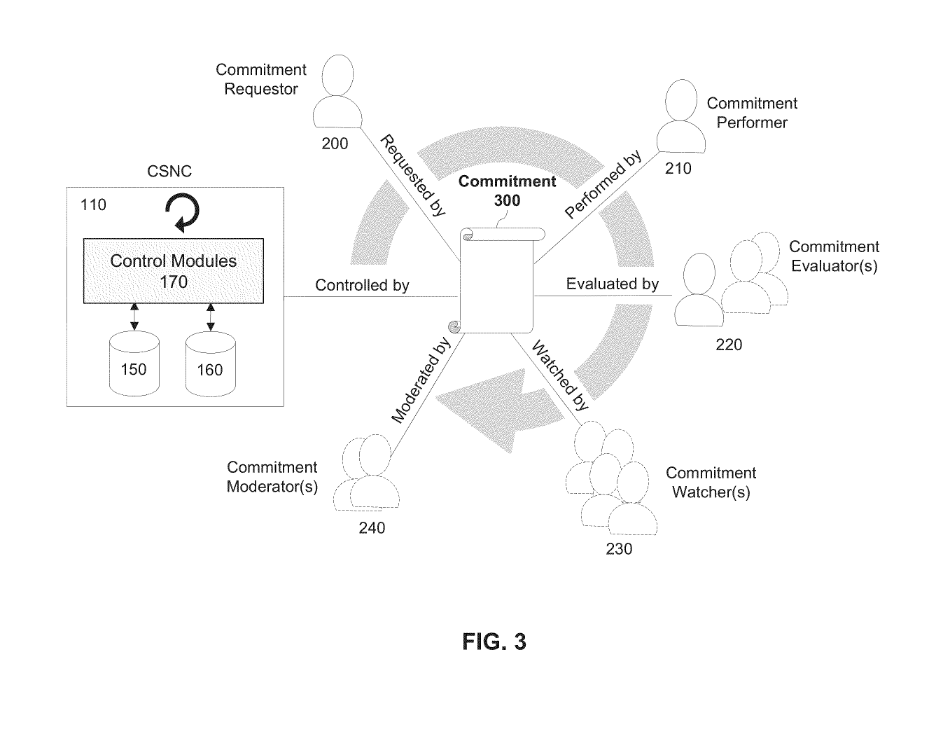

FIG. 3 is a content chart with CSN roles and a Commitment Social Network Controller (CSNC), and their main respective actions related to a Commitment, in accordance with an embodiment of the invention;

In one embodiment of the present invention, a Commitment 300 starts with a Commitment Requestor 200, who is mainly responsible for requesting a new Commitment to the CSNC 110 and elaborating a Commitment proposal. A Commitment Performer 210 is mainly responsible for accepting the commitment and performing actions to achieve the Commitment proposal statement goals for someone else or, in the case that the Commitment Requestor 200 and Commitment Performer 210 are the same entity, for himself/herself. a Commitment Evaluator 220 is mainly responsible for evaluating the performance of the Commitment Performer 210 and providing feedback regarding the achievement of the Commitment. A Commitment Watcher 230 is mainly responsible for watching the involved Commitment members' behavior with respect to a Commitment like an audience. A Commitment Moderator 240 is mainly responsible for moderating issues and conflicts and/or clarifying doubts. Finally, the CSNC 110 provides the necessary controls for the Commitment life cycle evolution, such as creation, elaboration, identification, certification, acceptance, performance, evaluation, feedbacks, reports, and commitment events notifications.

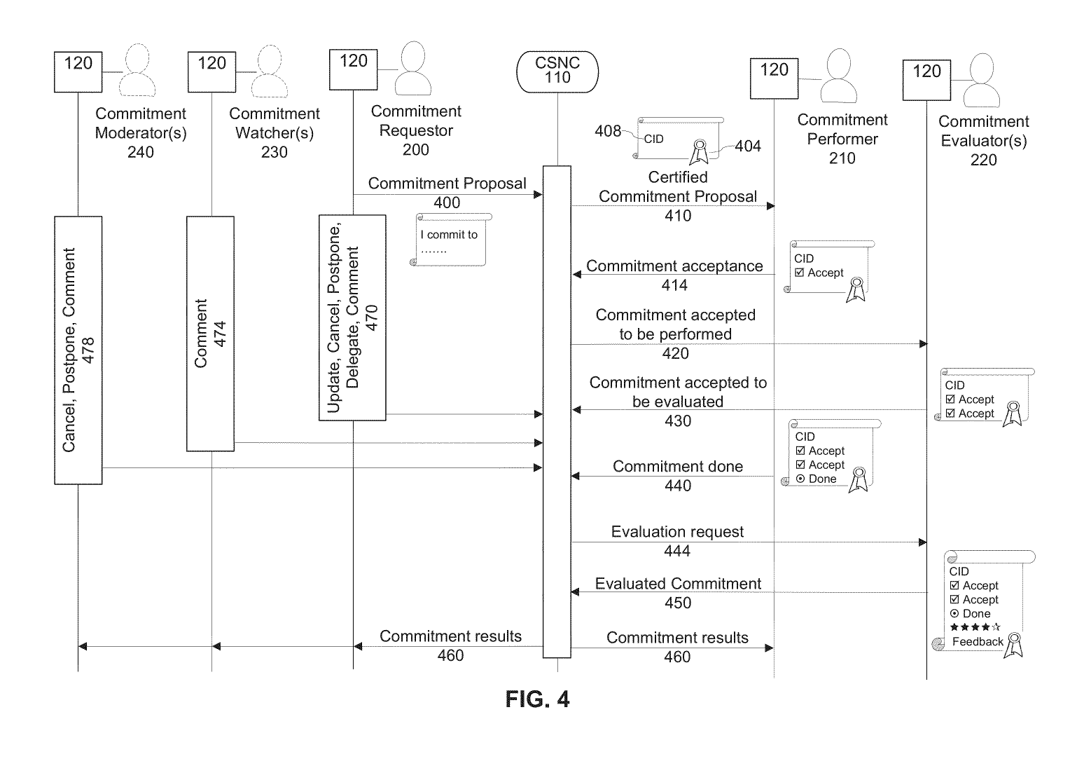

FIG. 4 is a sequence interaction flowchart with a Commitment life cycle evolution overview, in accordance with an embodiment of the invention.

In one embodiment of the present invention, a Commitment Requestor 200 requests a new Commitment from the CSNC 110 to enable him/her to create a Commitment proposal 400. Additionally, the Commitment Requestor 200 may also update, cancel, postpone, delegate and comment 470 on Commitments in order to manage them.

The CSNC 110 verifies the Commitment Requestor 200 authenticity through digital certification 404, or some other verification method, generates a Commitment unique identification (CID) 408, and sends a Certified Commitment proposal 410 to a Commitment Performer 210.

The CSNC 110 then receives the Commitment Performer's 210 Commitment Acceptance 414, and sends the Commitment accepted to be performed 420 to a Commitment Evaluator 220. Additionally, the Commitment Performer 210 may also add comments on Commitments.

In another embodiment, the Commitment Performer 210 may delegate Commitments to other members with the Commitment Requestor 200 agreement in order to provide a common agreement among all of them.

The Commitment Evaluator 220 agrees to evaluate the Commitment accepted to be performed 420. The Commitment accepted to be evaluated 430 is then sent to the CSNC 110. In case the same member is playing the Commitment Requestor 200 and Evaluator roles 220, the evaluation acceptance may not be necessary or may be done automatically.

Once the Commitment Performer 210 considers he/she has achieved the Commitment statement goals, he/she sends a Commitment done 440 indication to the CSNC 110 which sends an evaluation request 444 to the Commitment Evaluator 220 who is then responsible for evaluating the performance of the Commitment Performer 210 and Commitment goal(s) achievement. Alternatively, the CSNC 110 may send the evaluation request 444 to the Commitment evaluator 220 when the evaluation period has started.

The Commitment Evaluator 220 evaluates the Commitment Performer 210 performance and the Commitment goal(s) achievement through pre-defined ratings and feedback notes. The Evaluated Commitment 450, is then made available by CSNC 110 to the Commitment Requestor 200 and Commitment Performer 210, and may also be made available to all involved Commitment Members, including Commitment Moderator 240 and Commitment Watchers 230.

During the Commitment life cycle, the Commitment Watchers 230 or any other involved member may add comments 474, such as incentives, suggestions, help, alerts, opinions by texts, images, audio, video, URLs, e-mails, and attached elements. The Commitment Moderator 240 may cancel, postpone or add comments 478 on Commitments in order to: moderate possible issues or conflicts, clarify doubts, postpone Commitment periods, or even cancel Commitments in case there are unsolved issues and/or conflicts.

The steps described above need not be performed in the exact order as described. One of ordinary skill in the art will recognize that certain steps described may be rearranged, performed simultaneously, or omitted without departing from the spirit and scope of the present invention. Each role described may be filled by one or multiple parties, or all by the same party. It may be the case that a commitment requestor makes a private commitment to perform himself/herself, which is also self-evaluated.

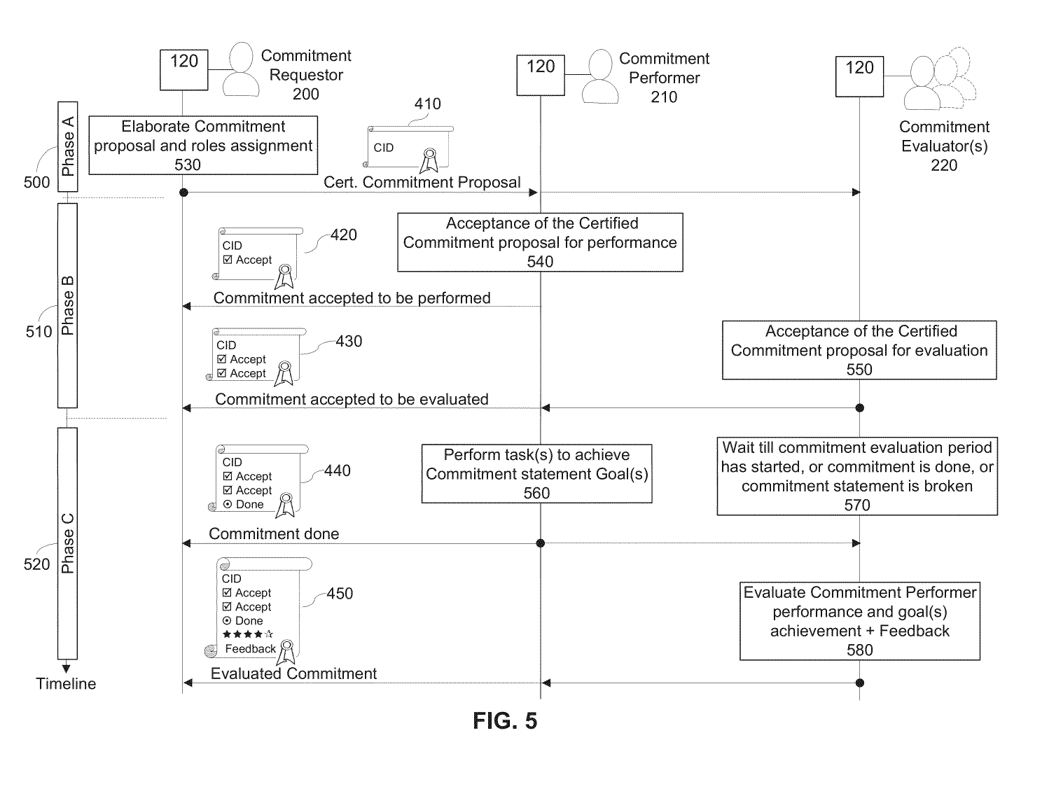

FIG. 5 is a sequence interaction flowchart with Commitment life cycle, describing the interactions among Commitment main roles and suggested main Phases (A, B, and C), in accordance with an embodiment of the invention.

In one embodiment of the present invention, Phase A 500 may comprise the elaboration 530 of the Commitment proposal 410 including roles assignment, verification criteria fulfilment, and the certification of authenticity of the Commitment Requestor 200 through the CSNC 110.

In one embodiment of the present invention, Phase B 510 may comprise the CSNC 110 receiving the acceptance 540 of the certified Commitment proposal 410 from the Commitment Performer 210, and the acceptance for evaluation 550 from the Commitment Evaluator 220.

In one embodiment of the present invention, Phase C 520 may comprise the Commitment Performer 210 performing tasks to achieve Commitment statement goals 560. Meanwhile, the Commitment Evaluator 220 waits until the commitment evaluation period has started, or commitment done indication is sent by Performer, or Commitment statement is broken 570, after any of these conditions the Commitment Evaluator 220 evaluates the Commitment Performer performance and goals achievement and gives his/her feedback 580 through the CSNC 110. After this evaluation, the Evaluated Commitment 450 and its associated feedback may be made available to all involved members through the CSNC 110.

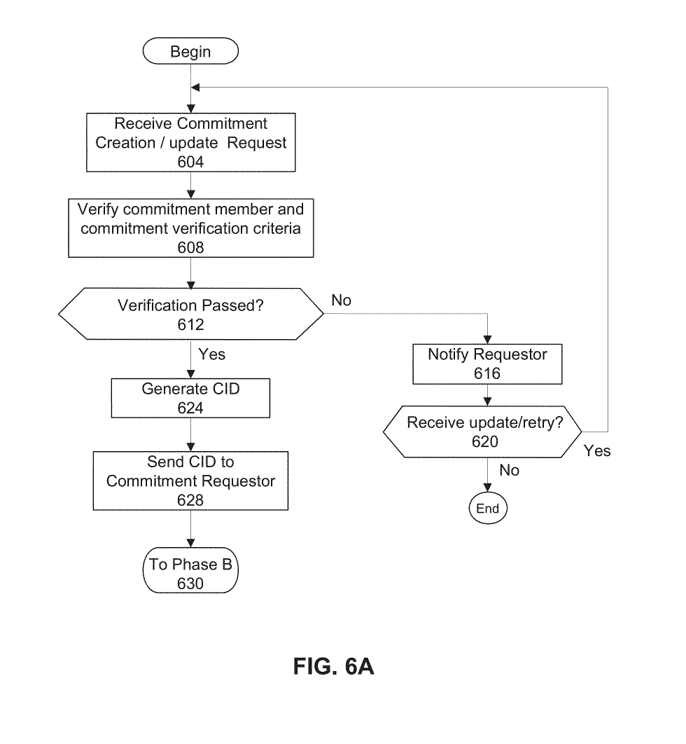

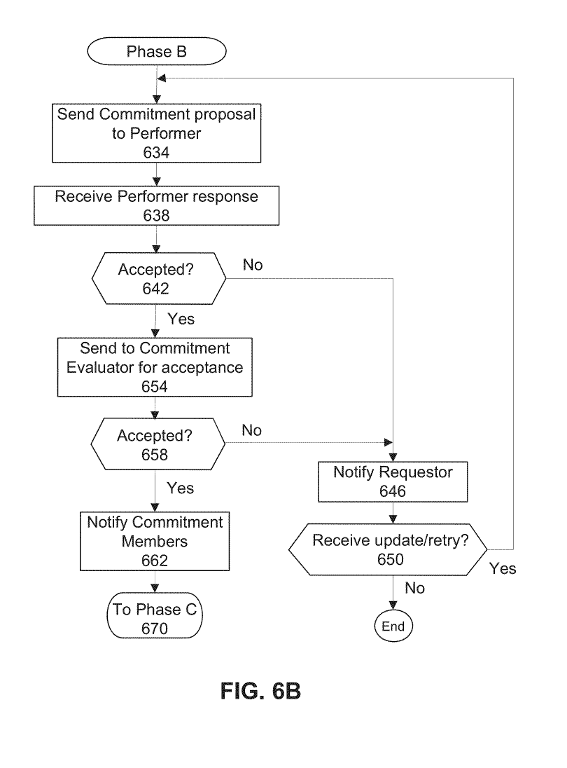

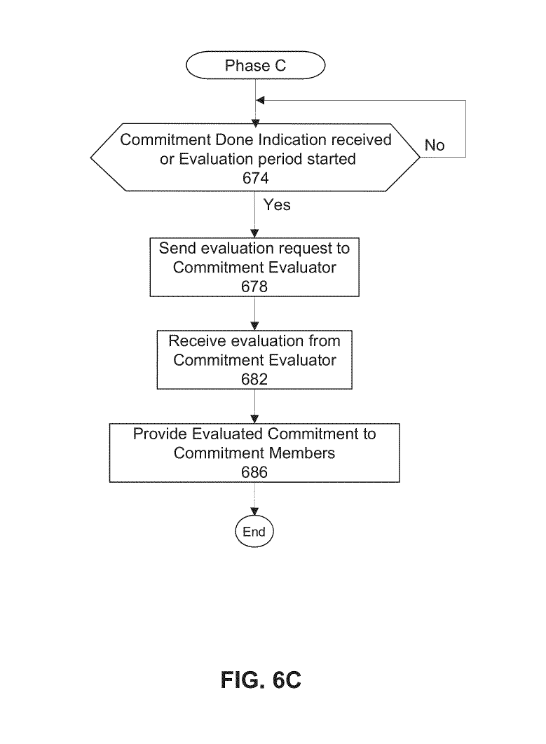

FIG. 6A is a flowchart of the function of the CSNC during Commitment life cycle Phase A: Commitment proposal creation and roles assignment (in more detail), in accordance with an embodiment of the invention.

In one embodiment of the present invention, the following steps describe Phase A 500. In step 604, the CSNC 110 receives a commitment creation and/or update request from the Commitment Requestor 200. This may be done in a variety of ways including sending commands and data required for a commitment to the CSNC 110, or creating a Commitment Proposal using locally installed software and then sending the completed commitment to the CSNC 110 for verification and presentation to one or more Commitment Members 140.

In step 608, the CSNC 110 verifies the Commitment Member 140 authenticity and checks the commitment to ensure that it meets the verification criteria, for example the “Commitment SMART criteria” (Specific, Measurable, Assignable, Realistic, Time-based). The CSNC 110 also verifies the availability of any members assigned to roles in the Commitment Request. If there are any issues 612 with the Commitment, the CSNC 110 notifies the Commitment Requestor 200 for a retry 616. At step 620, the CSNC 110 may receive updates from the Commitment Requestor 200 for another attempt. Otherwise, the commitment can be canceled and the process ends.

At step 624, the CSNC 110 generates a Commitment unique ID (CID) 408. At step 628, the CSNC 110 sends the CID to the Commitment Requestor 200. The Commitment Requestor 200 uses the CID to manage the commitment and receive updates on its status. The commitment life cycle then enters phase B at 630.

FIG. 6B is a flowchart of the function of the CSNC during Commitment life cycle Phase B: Commitment proposal analysis and acceptance (in more detail), in accordance with an embodiment of the invention.

In one embodiment of the present invention, the following steps describe Phase B 510. In step 634, the CSNC 110 sends the Commitment proposal 410 to the Commitment Performer 210 so the Commitment Performer can decide whether to accept the commitment. In Step 638, the CSNC receives a response from the Commitment Performer 210. In another embodiment, in order to protect the Commitment Performer 210 privacy, after the Commitment Performer 210 accepts the commitment, new Members role assignments can only be done with the Commitment Performer's 210 approval;

In step 642 the CSNC 110 checks the response, in case the Commitment Performer 210 rejects the commitment, the CSNC 110 notifies the Commitment Requestor 200 in step 646. At step 650, the CSNC 110 may receive updates from the Commitment Requestor 200 for another attempt. Otherwise, the commitment can be canceled and the process ends.

In step 654, the CSNC 110 sends the Accepted Commitment 420 to the Commitment Evaluator 220. The Commitment Evaluator 220 decides whether to evaluate the commitment. In case the same member is playing the Commitment Requestor and Evaluator roles, the evaluation acceptance may not be necessary or may be done automatically. If the Commitment Evaluator 220 decides to reject the role of Commitment Evaluator, the CSNC 110 notifies the Commitment Requestor 200 in step 646. At step 650, The CSNC can receive updates from the Commitment Requestor 200 and may return to step 634 to try again. Otherwise the commitment can be cancelled and the process ends. In step 662, the CSNC 110 sends the Commitment accepted to be evaluated 430, or a notification to all involved authorized Members; the CSNC 110 then moves to phase C 670.

FIG. 6C is a flowchart of the function of the CSNC during Commitment life cycle Phase C: Commitment Performer performance and goal(s) achievement evaluation (in more detail), in accordance with an embodiment of the invention.

In one embodiment of the present invention, the following steps describe Phase C 520: In step 674, the CSNC waits the reception of the Commitment done 440 indication from the Commitment Performer 210 or the start of the evaluation period; In step 678, the CSNC 110 sends the evaluation request to the Commitment Evaluator 220. The Commitment Evaluator 220 verifies that the commitment has been completed and provides feedback; In step 682, the CSNC 110 receives the evaluation from the Commitment Evaluator 220 and; sends the Evaluated Commitment 450 to all involved members in step 686.

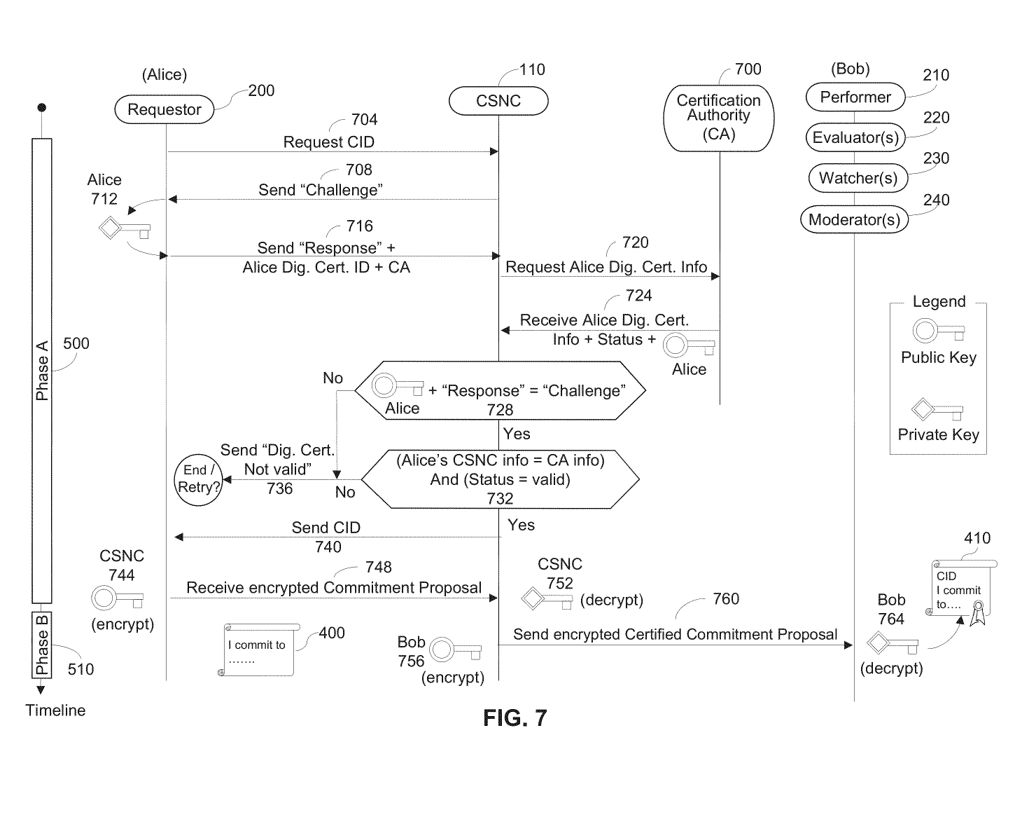

FIG. 7 is a sequence interaction flowchart with an additional security level, in order to assure Commitment members authenticity and Commitment contents encryption protection by digital certification prior art technology, in accordance with an embodiment of the invention.

In one embodiment of the present invention, the digital certification technology may be applied to formal Commitment establishments according to the following steps:

Step 704, the CSNC 110 receives a request for a new Commitment unique ID 408 from the Commitment Requestor 200;

Step 708, the CSNC 110 sends a “Challenge” value to the Commitment Requestor 200;

Step 712, the Commitment Requestor 200 uses his/her private key to encrypt the “Challenge” value into a “Response” value;

Step 716, the CSNC 110 receives from the Commitment Requestor 200 the “Response” value, his/her digital certification ID (and/or serial number), and the Certification Authority (CA) of his/her digital certification;

Step 720, the CSNC 110 requests from the informed Certification Authority 700 the digital certification info, status, and public key of the Commitment Requestor 200;

Step 724, the CSNC 110 receives from the Certification Authority 700 the digital certification info, status, and public key of the Commitment Requestor 200;

Step 728, the CSNC 110 uses the Commitment Requestor 200 public key to decrypt the “Response” value back to the “Challenge” value in order to compare with the sent “Challenge” value.

Step 732, in case of equal “Challenge” values, the CSNC 110 checks the contents of the digital certification info provided by the Certification Authority against stored info in the members database 150, and also checks if the digital certificate status is valid (not expired and/or not suspended);

Step 736, in case of different “Challenge” values, or any inconsistency in the digital certification info, or digital certification status not valid, the CSNC 110 sends the “Digital Certification not Valid” info to the Commitment Requestor 200, who may end or retry the process;

Step 740, if all checks are OK, authenticity has been certified, then the CSNC 110 sends the Commitment unique ID 408 to the Commitment Requestor 200.

Step 744, the Commitment Requestor 200 uses the available CSNC 110 public key to encrypt the Commitment proposal 400 contents.

Step 748, the CSNC 110 receives the encrypted commitment proposal from the Commitment Requestor 200;

Step 752, the CSNC 110 uses its private key to decrypt the encrypted Commitment proposal 400;

Step 756, the CSNC 110 uses the respective public key of each involved CSN member to encrypt the Commitment proposal 400;

Step 760, the CSNC 110 sends the encrypted Certified Commitment proposal 410 to each involved CSN member in this Commitment;

Step 764, each involved CSN member uses his/her own respective private key to decrypt the encrypted Commitment proposal 410.

In another embodiment, the digital certification security for source authenticity verification, and data encryption protection may be also applied to all kind of communication exchanged among all other Commitment members in any assigned role.

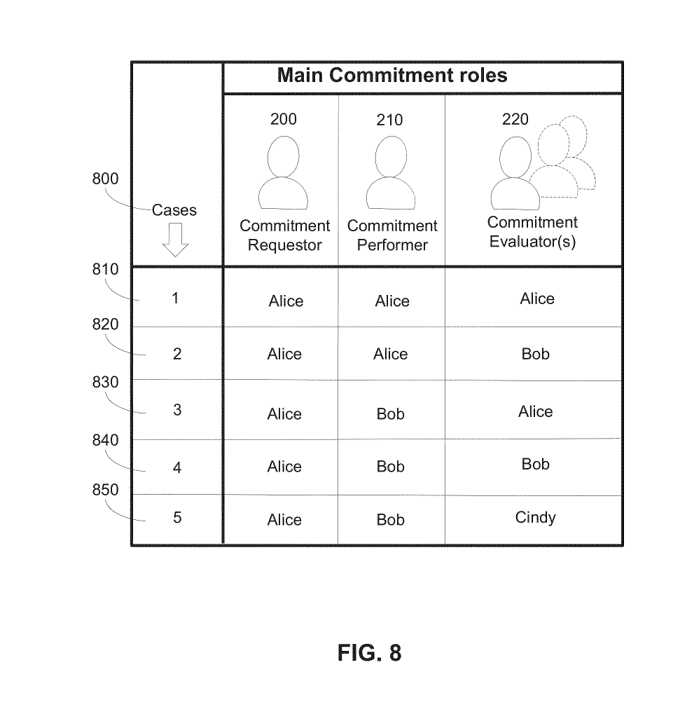

FIG. 8 is a table with main Commitment role assignment cases, in accordance with an embodiment of the invention.

In one embodiment of the present invention, the Commitment role assignments may have different cases 800, which may be useful for different situations. In order to increase explanation clarity only the main roles of Commitment Requestor 200, Commitment Performer 210, and Commitment Evaluator(s) 220 are shown here, associating each role with a single person. The used names are standard names used in Encryption discipline, such as Alice, Bob, and Cindy, and are also used throughout this invention description.

The first case 810 shows when Alice wants to play all roles in a Commitment 300, which may be suitable for a Commitment 300 in a private environment. The second case 820 shows when Alice wants to play the roles of Commitment Requestor 200 and Commitment Performer 210 at the same time, and invites Bob to play the role of Commitment Evaluator 220, which may be suitable to increase evaluation fairness. The third case 830 shows when Alice wants to play the role of Commitment Requestor 200 and Commitment Evaluator 220, and invites Bob to play the role of Commitment Performer 210, which can be considered the most common case and suitable for most commitments between two members.

The fourth case 840 shows when Alice wants to play the role of Commitment Requestor 200 and invites Bob to play the roles of Commitment Performer 210 and Commitment Evaluator 220 at the same time, which can be considered the least common case, but suitable for a self-assessment requested by someone else;

Finally, the fifth case 850 shows when Alice wants to play the role of Commitment Requestor 200, invites Bob to play the role of Commitment Performer 210, and Cindy to play the role of Commitment Evaluator 220, which may be the broad case to demonstrate the differences of each Commitment role participation in a Commitment 300. It may be suitable to be used when the Commitment Requestor 200 prefers a third person expertise or even more impartiality in the evaluation.

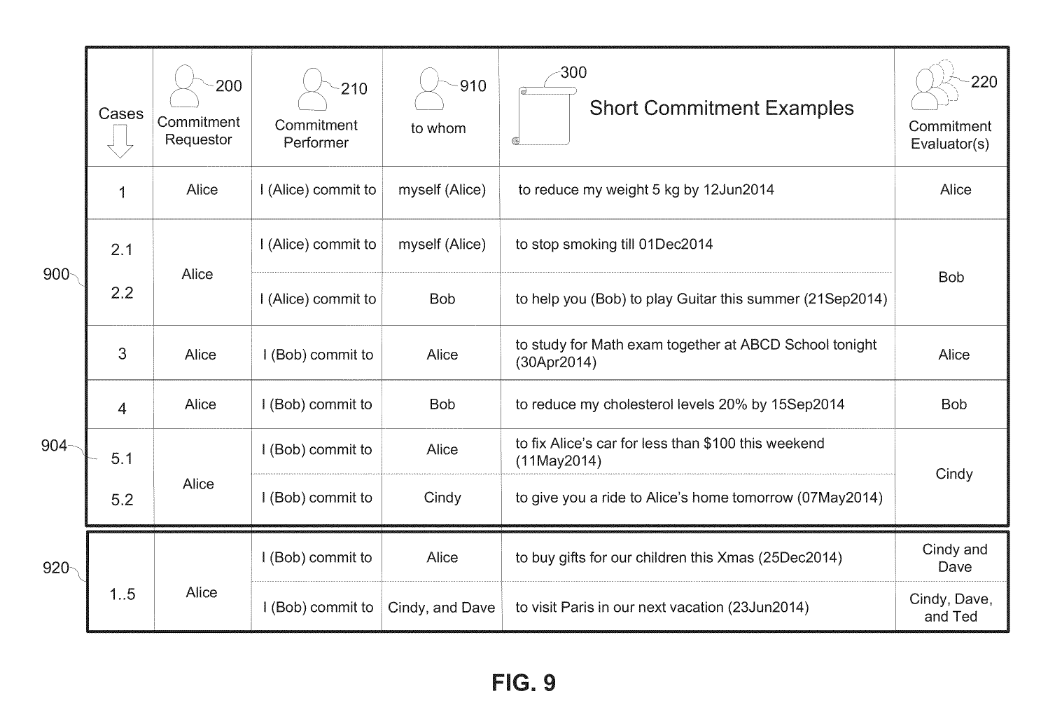

FIG. 9 is a table with the main Commitment role assignment cases, including short Commitment statement examples, in accordance with an embodiment of the invention.

In one embodiment of the present invention, the presented Commitment table 900 shows Commitment role assignments and short statement examples to illustrate the different Commitment cases 800. Exploring in more detail the fifth case, example 5.1 904, where the Commitment Requestor 200 Alice elaborates the Commitment statement proposal to the Commitment Performer 210 (Bob) using the first-person style, that is, assuming the Commitment Performer 210 as the subject [in this case: I (Bob)]. Then, follows the verb “commit” in its infinitive form (commit to), to whom 910 the Commitment is addressed to (in this case: Alice), and the complement of the statement (in this case: to fix Alice's car for less than $100 this weekend (11May2014)). What results in the following Commitment statement: “I (Bob) commit to Alice to fix Alice's car for less than $100 this weekend (11May2014)” and “be evaluated by Cindy”.

A few more examples 920 are given to show other cases where more than one member may assume the role of Commitment Evaluator 220 and/or to whom 910 the Commitment may be addressed.

### Operation

The next Figures describe embodiments illustrating the operation of the CSN user interface by mere examples and should not be interpreted as restrictive for this invention.

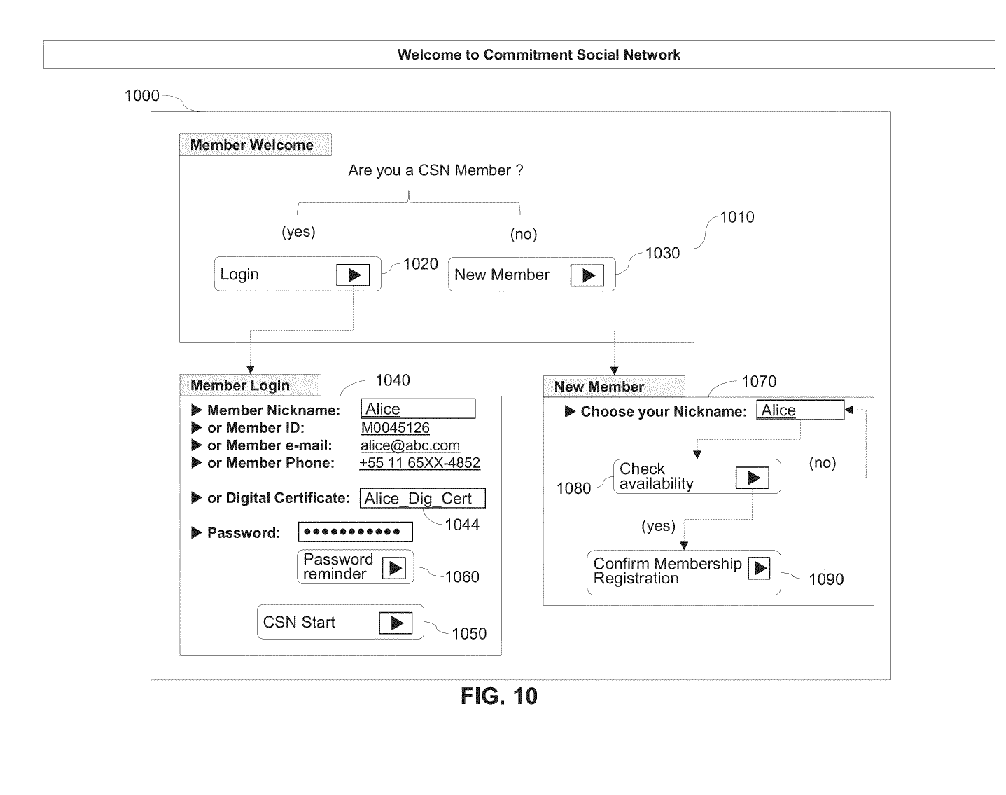

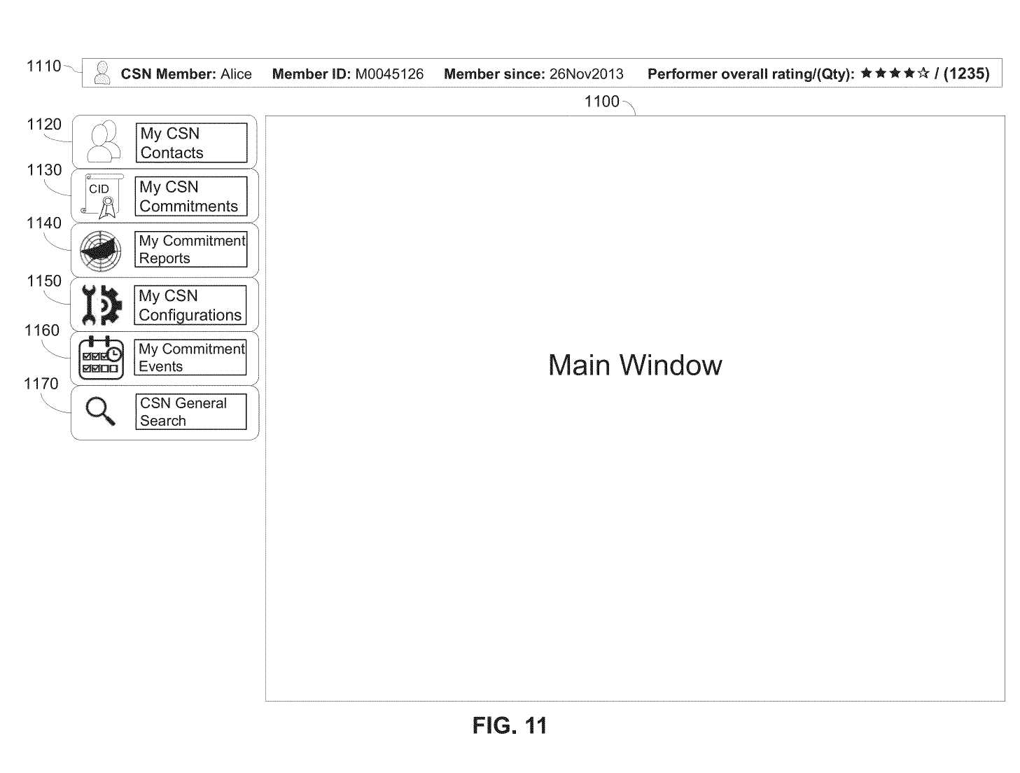

FIG. 10 is an example screenshot illustrating a CSN login interface, in accordance with an embodiment of the invention.

In one embodiment of the present invention, the CSN login interface screenshot 1000 may comprise a member welcome menu 1010, which asks the user if he/she is already a CSN member 140. Members hit the login button 1020, otherwise the user hits the new member button 1030.

The member login menu 1040 may provide different identification access methods to CSN members 140, such as member nickname, or member ID, or member e-mail, or member phone, or any other unique identification. After selecting the preferred way for identification, the member types in his/her password followed by hitting the CSN start button 1050. In case of forgetfulness, the CSN member 140 may hit the password reminder button 1060 to receive from CSNC 110 a password reminder message like: “My Pet's name” previously provided by the member in his/her profile.

In another embodiment, the CSN member 140 may use his/her Digital Certificate 1044 for login in order to provide extra security and certification of authenticity.

The New Member menu 1070 may be used to choose a new member unique nickname, whose availability may be checked by hitting the check availability button 1080. In case the selected nickname is already in use, the new member may try another one until an available nickname is chosen. In case of available unique nickname, the new member hits the confirm membership registration button 1090 in order to become a registered CSN member 140.

FIG. 11 is an example screenshot illustrating a CSN main user interface, in accordance with an embodiment of the invention.

In one embodiment of the present invention, the CSN main user interface may comprise a main window 1100, a top banner 1110, and several quick access buttons 1120 . . . 1170 (in the left side of the Main Window 1100).

The Main Window 1100 may be used to present selected information and receive user's inputs.

The top banner 1110 may be used to present several general information, such as member photo, member nickname, member ID, member since date, member overall ratings as Performer, and/or any other general info or reminders previously selected by member's preference.

The several quick access buttons, such as My CSN Contacts 1120, My CSN Commitments 1130, My Commitment Reports 1140, My CSN Configurations 1150, My Commitment Events 1160, CSN General Search 1170, and/or any quick access button are intended to help users' navigation throughout the CSN interactions.

In another embodiment, the organization of the layout may be rearranged due to screen sizes and/or member interface apparatus 120 operating system style.

Each of these main quick access buttons and the main concepts behind them are described in the following Figures accordingly.

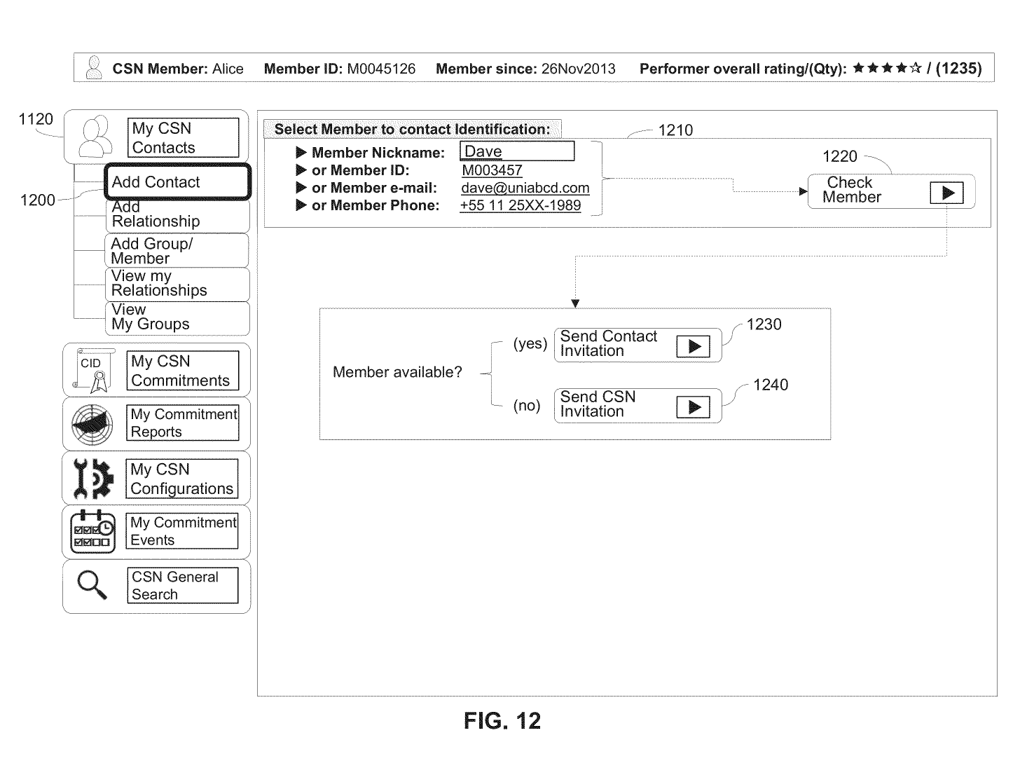

FIG. 12 is an example screenshot illustrating how to add a member as a contact, or to invite one to become a new member of the CSN, in accordance with an embodiment of the invention.

In one embodiment of the present invention, hitting the My CSN contacts 1120 quick access button followed by Add contact button 1200 opens a Select member to contact identification menu 1210, which requests a unique identification method such as, member nickname, or member ID, or member e-mail, or member phone, in other words, at least one piece of information related to the member being contacted. After the selection, the member hits the Check member button 1220: in case the contact is already a member, pops up the Send contact Invitation button 1230 in order to establish the members contact; otherwise, pops up the Send CSN invitation button 1240 in order to invite the person/entity to become a CSN member 140.

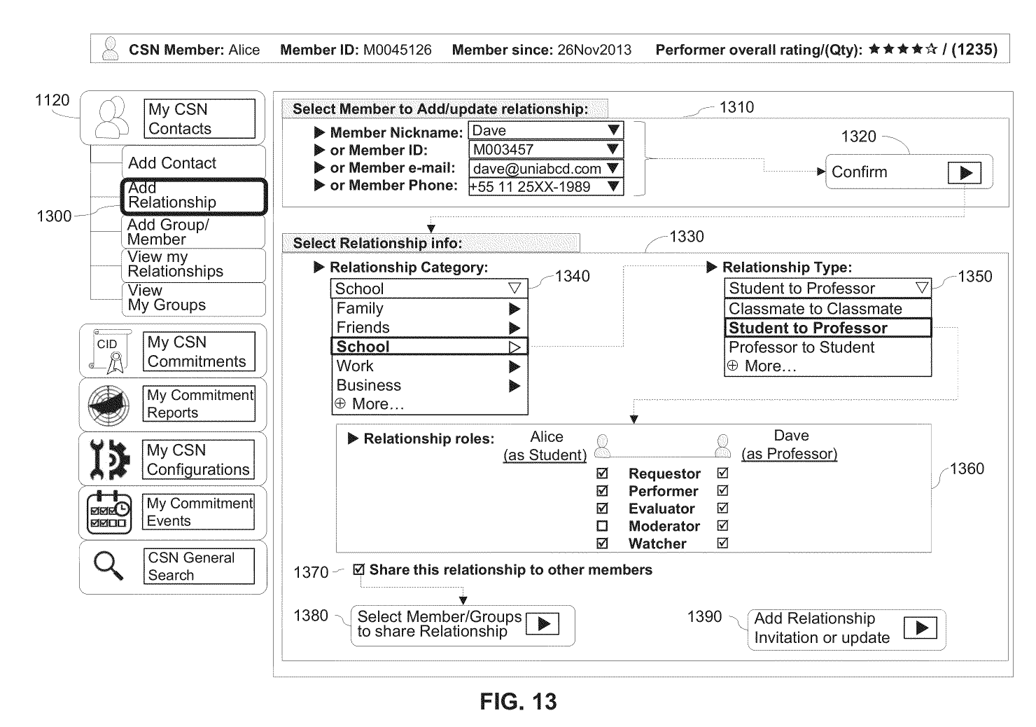

FIG. 13 is an example screenshot illustrating how to add a relationship among members including its category, type and possible roles in a relationship, in accordance with an embodiment of the invention.

In one embodiment of the present invention, hitting the My CSN contacts 1120 quick access button followed by Add/update relationship button 1300 opens a Select member to add/update relationship menu 1310 which requests a member identification. After the member selection and confirmation by hitting Confirm button 1320, opens a Select relationship info menu 1330, where the member may select the relationship category 1340, such as family, friends, school, work, business, ⊕ more. After this selection, the content of the associated relationship type 1350 menu is made available accordingly, giving the member some options of relationship type 1350, such as classmate to classmate, student to professor, professor to student, ⊕ more. Finally, after that, the member may select the roles allowed to be played for himself/herself and for the member involved in this specific relationship category and relationship type 1360. In this specific example Alice did not want to play the role of Moderator in the relationship type student to professor, but all other roles were selected as allowed for both members (Alice and Professor Dave).

Based on this principle, it may be possible to allow different roles selection for each relationship category and relationship type. For example, Alice and Dave may have an extra relationship in the category school but with relationship type classmate to classmate, once they are both in the same guitar class as students and may select other roles allowance accordingly.

Additionally it may be available the option to share this relationship with other member(s) and/or group(s) 1370. If the member wants to keep this specific relationship private, this option should be unchecked; otherwise, if the member wants to keep this specific relationship public, the Select members/groups to share relationship button 1380 is enabled to select the member(s)/group(s) to share this relationship info with.

Finally the member hits the Add relationship invitation or update button 1390, in order to request acceptance from the other member of the selected relationship conditions.

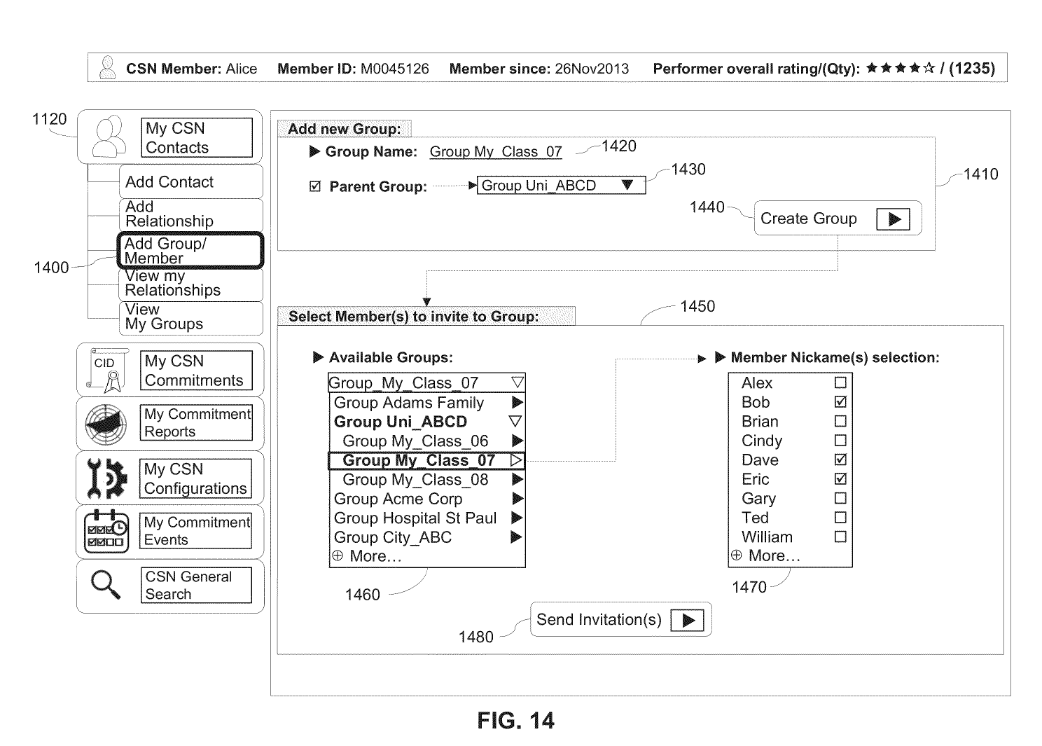

FIG. 14 is an example screenshot illustrating how to add a group and/or invite a member to join a group of member(s), in accordance with an embodiment of the invention.

In one embodiment of the present invention, hitting the My CSN contacts 1120 quick access button followed by Add group/member button 1400 opens an Add new group menu 1410 which requests the group name 1420 to be added and, optionally, a parent group 1430 which may be used to organize a group/sub-group tree structure. After that, the member may hit the Create group button 1440.

The Select member(s) to invite to group menu 1450 provides the possibility to select a group (from the tree structure of the available groups menu 1460) which the member wants to add/invite other member(s) using the member nickname(s) selection menu 1470 to participate in this selected group. After this selection, the member hits the Send invitation(s) button 1480 to invite the selected member(s).

In this specific example, Alice added the group Group_My_Class_{—}07 as a sub-group of already available group named Group_Uni_ABCD and selected Bob, Dave, and Eric to be invited to participate on this added group.

In another embodiment, it may be possible to manage the groups with higher complexity, such as member removal, member addition, group owners, group administrators, and/or any kind of member group management task, which are not described here to not obscure the invention main principles.

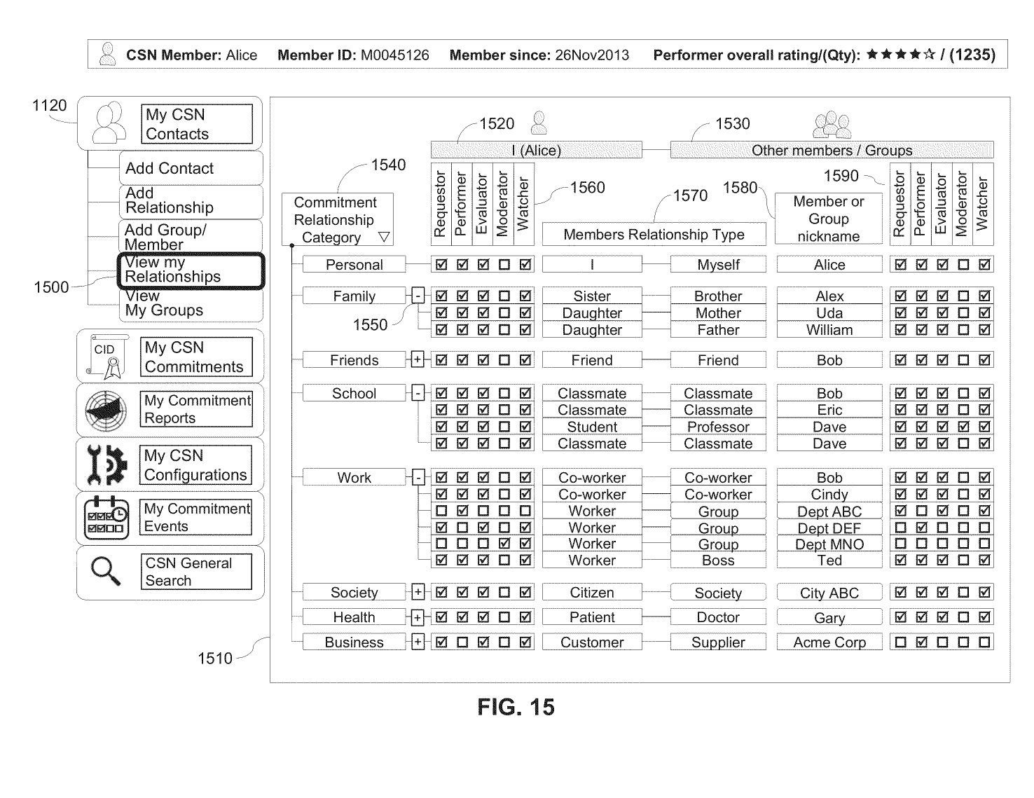

FIG. 15 is an example screenshot illustrating a summary view with info about members relationship structured by relationship category, relationship type, and selected allowed roles from a member perspective, in accordance with an embodiment of the invention.

In one embodiment of the present invention, hitting the My CSN contacts 1120 quick access button followed by View my Relationships button 1500 opens a relationship summary 1510 between the member in focus 1520 (in this example Alice) and all other members or groups with already established relationships 1530.

The relationship summary 1510 may comprise: a Commitment relationship category tree structure 1540 which can be expanded and collapsed 1550 for each relationship; all selected allowed roles 1560 for member in focus; the members relationship type 1570 for all available relationships; the member or group nicknames with established relationships 1580; and all selected allowed roles for other members or Groups with established relationships 1590.

This kind of relationship summary 1510 may be a very powerful manner to show several relationships ways that members may have among them. In this specific example Alice and Bob have a friend to friend relationship type in relationship category friends, a classmate to classmate relationship type in relationship category school, and a co-worker to co-worker relationship type in relationship category work. This method of organizing relationships may be very relevant in the Commitment Social Network context, because people and even Organizations may have different Commitment behaviors according to the relationship category and relationship type they are dealing with.

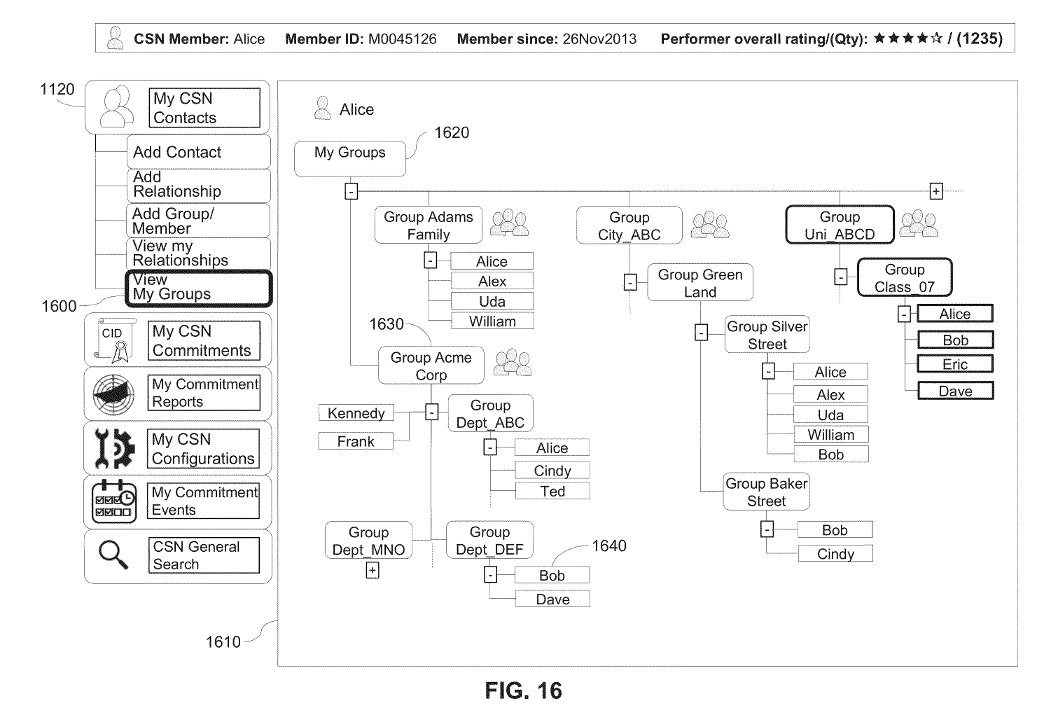

FIG. 16 is an example screenshot illustrating a summary with info about groups and sub-groups and their respective members, in accordance with an embodiment of the invention.

In one embodiment of the present invention, hitting the My CSN contacts 1120 quick access button followed by View my groups button 1600 opens a groups summary 1610, which may be organized by the groups tree structure 1620, optional sub-groups 1630 as branches, and the respective members of the group 1640 as leaves of the tree. In this specific example Alice belongs to several groups and sub-groups with different members, that is, she and Bob belong to Group_Class_{—}07 (sub-group of Group_Uni_ABCD), Group Silver Street (sub-group of Green_Land, which is sub-group of group City_ABC), and group Acme Corp in different sub-group departments (Group_Dept_ABC and Group_Dept_DEF respectively).

This kind of group and sub-group summary 1610 may be a very powerful manner to show several members grouping structures. This structured method to organize groups and sub-groups may be very relevant in the Commitment Social Network invention because people and even Organizations may have different Commitment behaviors according to the groups and sub-groups they belong to.

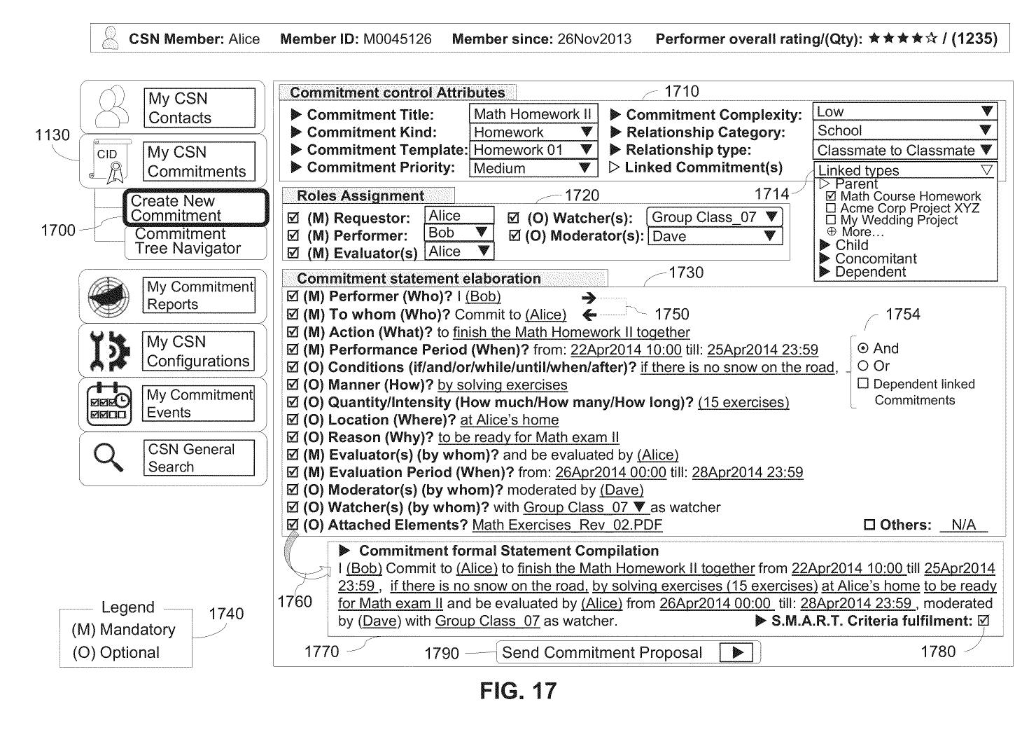

FIG. 17 is an example screenshot illustrating a new Commitment proposal elaboration with main Commitment control attributes selection, roles assignment, and an environment for a Commitment formal statement elaboration and compilation, in accordance with an embodiment of the invention.

In one embodiment of the present invention, hitting the My CSN Commitments 1130 quick access button followed by Create new Commitment button 1700 opens a Commitment control attributes menu 1710, which may be used by Commitment Requestor 200 to select the respective control attributes, such as Commitment title, Commitment kind, Commitment template, Commitment priority, Commitment complexity, relationship category, relationship type, and linked Commitment(s).

All these control attributes may be used to organize and manage the Commitments in several formats, such as Navigation trees, tables, reports, and graphs according to specific member's preference, or even as a pre-defined group's preference.

In another embodiment, the linked Commitment(s) drop down menu 1714 may be used to select different Commitment link types, such as parent, child, concomitant, and dependent to other Commitments. The parent and child link types may be used to organize Commitments in a structure format such as a tree; the concomitant link type may be used to link two or more commitments that coexist at the same time and share inter-related goal(s), such as bets, marriage, contracts, exchanges, and/or similar; finally, the dependent link type may be used as a condition to trigger one or more Commitments that has/have inter-dependencies, such as to start one only after the start of the other, or start one only after the finish of the other.

In this specific example, Alice started the Math homework Commitment by selecting the appropriate control attributes. Specifically, the linked Commitments drop down menu 1714 is highlighted, selecting the Uni_ABCD Math Course as the parent Commitment.

After that, the Commitment Requestor 200 assigns member(s) and/or group(s) to the Commitment roles: Commitment Performer 210, Commitment Evaluators(s) 220, and optionally, to Commitment Watcher(s) 230, and to Commitment Moderator(s) 240, through the roles assignment menu 1720.

After that, the Commitment Requestor 200 starts to elaborate the Commitment statement through the Commitment statement elaboration menu 1730, which may comprise several pre-defined (M) Mandatory and (O) Optional 1740 questions according to each Commitment kind template 2550.

In this specific example, the Commitment kind homework 01 template was selected having the following questions descriptions: the first two questions Performer (Who) and To whom (Who) 1750 are normally used to establish the Commitment social network graph 2370. The Action (What) question may be used to define the main Commitment goal(s); the Performance period (When) question, as the name suggests, may be used to define the performance period; the conditions (if/and/or/while/until/when/after) question may be used to create all logical rules to satisfy and/or complement the Commitment goal(s) plus optionally other dependent linked Commitments 1754; the Manner (How) question may be used to explain the manner to achieve the goal(s); the Quantity/Intensity (How much/How many/How long) question may be used to define measurement info; the Location (Where) question may be used to define place of Commitment establishment and/or performance; the Reason (Why) question may be used to justify the need of the Commitment; the Evaluator(s) (by whom) question may be automatically answered from the roles assignment menu 1720; the Evaluation Period (When) may be used to define the Commitment's evaluation period; the Moderator(s) (by whom) and Watcher(s) (by whom) questions may be also automatically answered from the roles assignment menu 1720.

Additionally, it may be possible to attach any kind of elements, such as a text, an image, an audio, a video, a URL, an email, a drawing, a portable document format, a file, a compacted file, a program, or even another commitment, in order to clarify and/or support the Commitment description and its evolutions.

After filling in all mandatory and optional questions the CSNC 110 may compile automatically 1760 the answers to build up the Commitment formal Statement Compilation 1770. In this specific example the compilation result may be the following: “I (Bob) Commit to (Alice) to finish the Math Homework II together from 22Apr2014 10:00till 25Apr2014 23:59, if there is no snow on the road, by solving exercises (15 exercises) at Alice's home to be ready for Math exam II and be evaluated by (Alice) from 26Apr2014 00:00 till: 28Apr2014 23:59, moderated by (Dave) with Group Class 07 as watcher”.

In one embodiment of the present invention, from the answers of the questions, it may be possible to verify automatically the Commitment formal statement fulfilment by the prior art so called “S.M.A.R.T. criteria” 1780, which was originally created to verify a goal but its main concepts may be extended to verify a commitment statement too, by checking if specific questions were answered. It may comprise the following topics and respective questions:
S (Specific): a specific goal is distinct and defines as much of the goal as possible and contains no ambiguous language (Questions are: What, Where, How and Why);
M (Measurable): a measurement gives feedback and let's one know when the goal may be considered complete (Questions are: How much, or how many, or how long);
A (Assignable): goals must be assignable to individuals or groups (Questions are: Who and to whom);
R (Realistic): realistic goals are challenging yet attainable within the given resources and timeframe (Questions are: How, Who, When, and/or how long);
T (Time-Based): a goal must have a defined due date or a period of time to be achieved (Questions are: When and/or how long).

In another embodiment, the verification criteria may be done by simple checking if all the Mandatory Questions of the Commitment Template were answered.

After that, the Commitment Requestor 200 sends the Commitment proposal 400 by hitting the Send Commitment proposal button 1790.

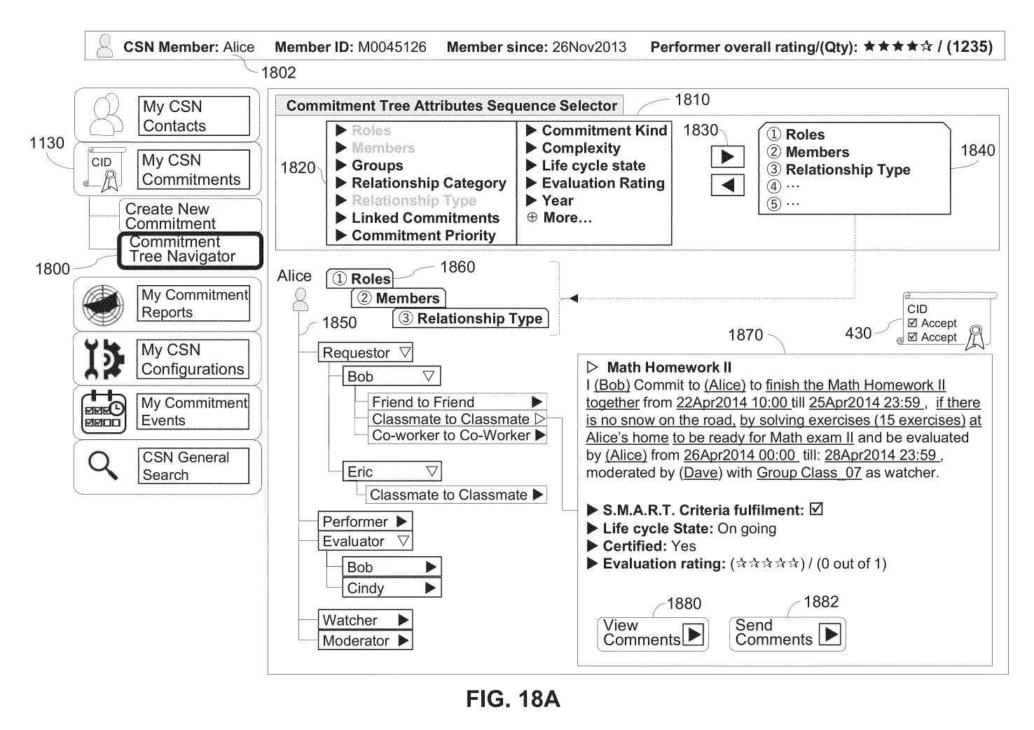

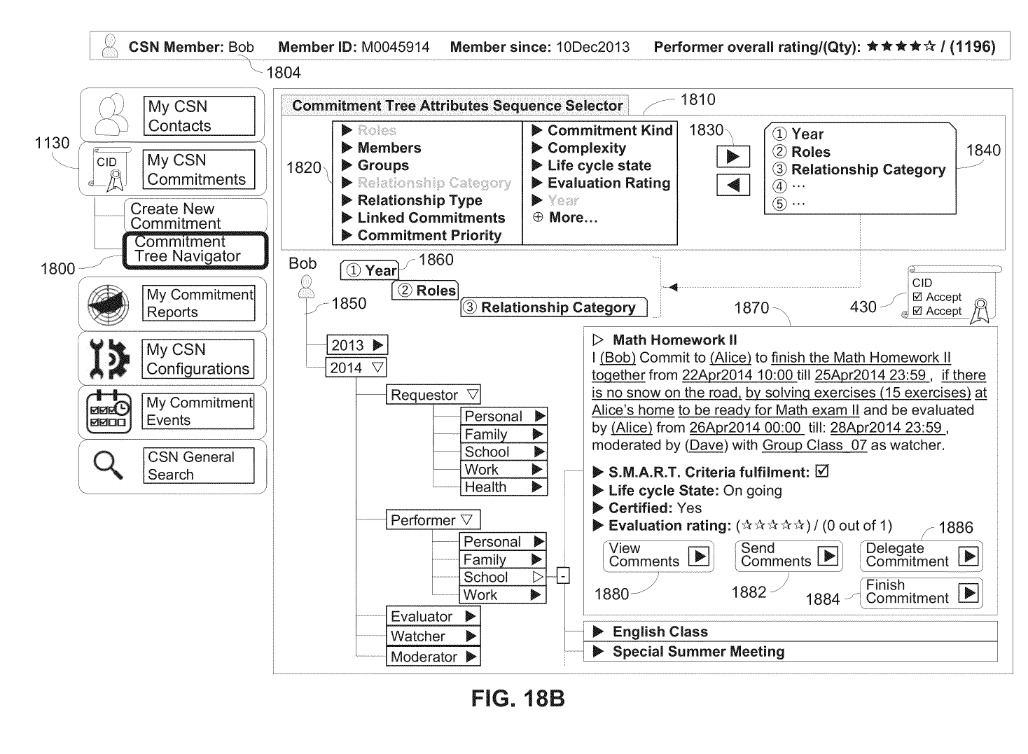

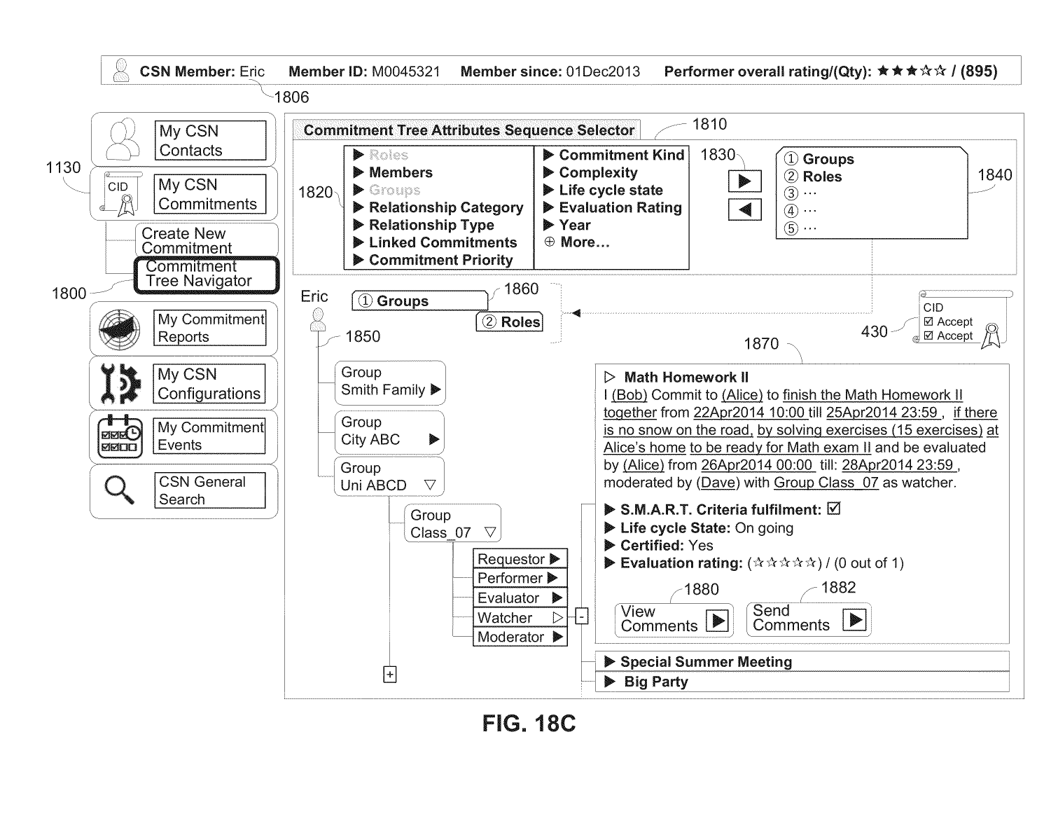

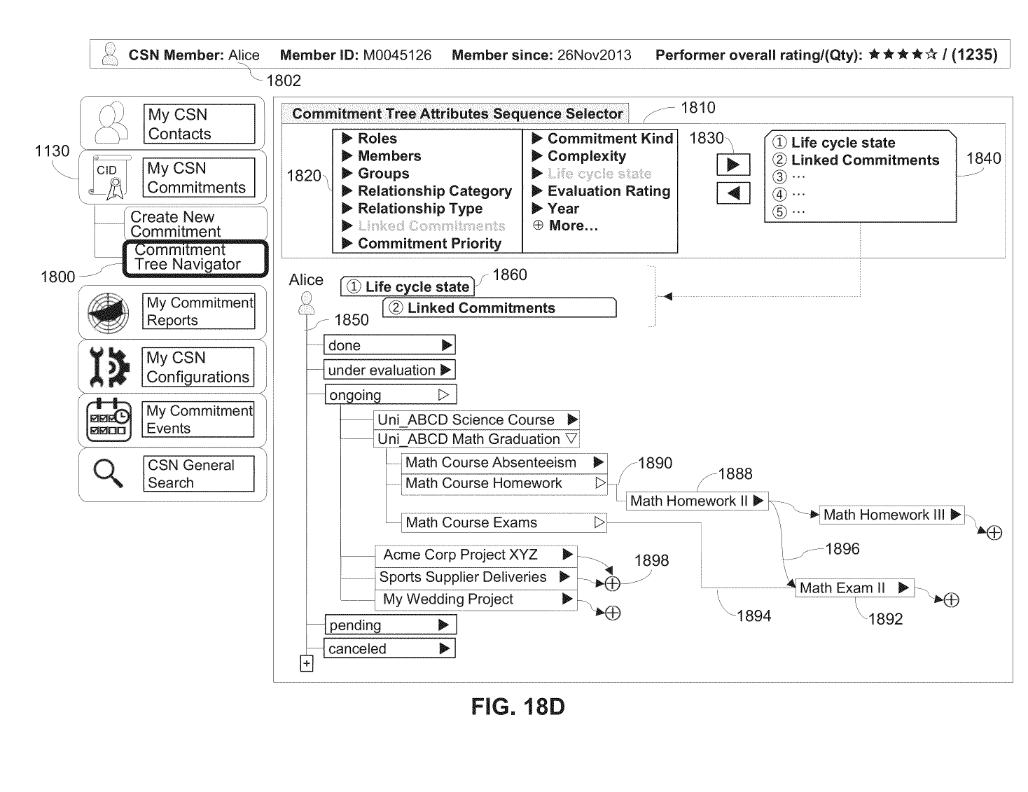

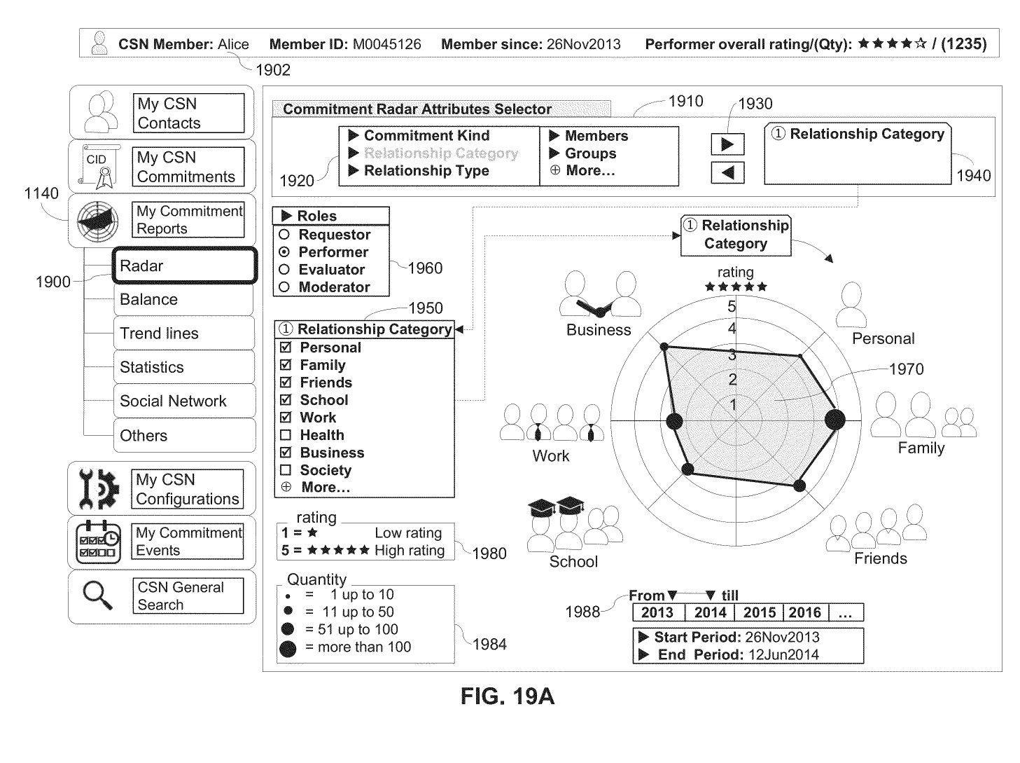

FIG. 18A is an example screenshot illustrating a dynamic Commitment tree structure navigator which may be built based on Commitment control attributes sequence selector according to member (Alice) preferences, in accordance with an embodiment of the invention.

In one embodiment of the present invention, hitting the My CSN Commitments 1130 quick access button followed by Commitment tree navigator button 1800 opens a Commitment tree attributes sequence selector menu 1810, which presents the Commitment control attributes 1820 to be chosen 1830 in a sequential navigation format 1840 in order to organize the Commitment navigation tree 1850 according to an individual member's preference. In this specific example, the Commitment Performer Alice 1802 selected the following control attributes sequence: \textcircled{1} roles, \textcircled{2} members and \textcircled{3} relationship type, which creates a type of Commitment tree with this sequence navigation organization 1860.

The Commitments are the leaves of this tree, which can be opened to access its details 1870 for analysis and actions. Still in this specific example, Alice opened the Commitment requestor role (first attribute: roles), followed by member Bob (second attribute: members), followed by relationship type classmate to classmate (third attribute: relationship type), and finally opened the Evaluation Accepted Commitment 430, which has the following info: Commitment statement, SMART criteria fulfilled, life cycle state On going, already certified by CSNC, and evaluation ratings pending. Finally, the Commitment action buttons View Comments 1880 and/or Send Comments 1882 may be available.

Depending on the Commitment life cycle state and the member role, more or less action button(s) may be presented accordingly, such as, View Comments, Send Comments, Accept Commitment, Reject Commitment, Accept Evaluation, Reject Evaluation, Finish Commitment, Evaluate Commitment, and/or any other necessary action to be done.

FIG. 18B is an example screenshot illustrating another dynamic Commitment tree structure navigator which may be built based on Commitment control attributes sequence selector according to member (Bob) preferences, in accordance with an embodiment of the invention.

In this specific example, the Commitment Performer Bob 1804 selected the following control attribute sequence: \textcircled{1} year, \textcircled{2} roles and \textcircled{3} relationship category 1840. This selection creates the Commitment tree 1850 which may be based on the sequence navigation organization 1860. In this case, Bob opened the year 2014 (first attribute: year), followed by the role of Performer (second attribute: roles), followed by relationship category school (third attribute: relationship category), and finally opened the Evaluation Accepted Commitment 430, which is also the same Commitment already opened by Alice.

In this current situation Bob as a Commitment Performer 210 may select the following action buttons: View Comments 1880, Send Comments 1882, and Finish Commitment 1884.

In another embodiment, it may be possible to use the special resource to delegate the Commitment Performer role 210 to another member by hitting the Delegate Commitment button 1886.

FIG. 18C is an example screenshot illustrating another dynamic Commitment tree structure navigator which may be built based on Commitment control attributes sequence selector according to member (Eric) preferences, in accordance with an embodiment of the invention.

In this specific example, the Commitment Watcher Eric 1806 selected the following control attribute sequence: \textcircled{1} groups and \textcircled{2} roles 1840, which creates a Commitment tree 1850 with this sequence navigation organization 1860. In this example, Eric opened the group Group_Uni_ABCD (first attribute: group), followed by sub-group Group_Class_{—}07, followed by Watcher role (second attribute: roles), and finally opened the Evaluation Accepted Commitment 430, which is also the same Commitment already opened by Alice and Bob.

FIG. 18D is an example screenshot illustrating another dynamic Commitment Tree structure navigator which may be built based on Commitment control Attributes Sequence Selector according to member (Alice) other preferences, in accordance with an embodiment of the invention.

In this specific example, the Commitment Performer Alice 1802 selected the following control attribute sequence: \textcircled{1} life cycle state and \textcircled{2} linked Commitments 1840, which creates a Commitment tree 1850 with this sequence navigation organization 1860. In this example, Alice opened the ongoing (first attribute: life cycle state), followed by Uni_ABCD Math Graduation, followed by Math Course Homework and Math Course Exams (second attribute: linked Commitments).

The result of these selections may be the presentation of available linked Commitments under this specific scope, and their respective link types. In the case of Math Homework II Commitment 1888, it has a parent link type to Math Course Homework 1890. In the case of Math Exam II Commitment 1892, it has a parent link type to Math Course Exams 1894, and at the same time a dependent link type to Math Homework II Commitment 1896. The ⊕ sign 1898 may be used to indicate hidden linked Commitments. Therefore it may be possible to build up a very complex Linked Commitment structure with very different Commitment scopes among different members from several different groups.

Based on the described examples Figures, it is already possible to realize the high flexibility of the Commitment dynamic tree navigation resources and its great commitment management power.

FIG. 19A is an example screenshot illustrating a Commitment radar report, which may be built dynamically based on different attributes selected by a member, in this specific example “relationship category”, in accordance with an embodiment of the invention.

In one embodiment of the present invention, hitting the My Commitment reports 1140 quick access button followed by Radar button 1900 opens a Commitment radar attributes selector menu 1910, which presents the control attributes 1920 to be chosen 1930 as the radar info 1940. In this specific example, the Commitment Performer Alice 1902 selected the relationship category, which opens the menu 1950 to select the relationship category items to be displayed in the radar report 1970. Additionally the roles menu 1960 may be also available to select the specific role under consideration to be displayed, in this specific case, Alice selected the role of Performer.

In one embodiment of the present invention, the radar report 1970 presents a data point for each selected item 1950 of the selected Commitment attribute 1940 with distance to the center proportional to the Commitment average rating 1980, and the size of the dots may be proportional to the quantity of Commitments 1984. Additionally, it may be possible to select the period under consideration 1988.

In this specific radar report 1970, Alice, as Commitment Performer 1960, has higher Commitment rating in family and in business relationship categories (both with 4 stars ⋆⋆⋆⋆). But, comparing both categories, she has higher quantity of commitments in the family relationship category, what is represented by a larger dot. At the same time, Alice has low Commitment rating in the work and school relationship categories.

This kind of visualization may be very useful to analyze a member Commitment behavior regarding different points of view, such as other members, groups, Commitment kinds, relationship categories, relationship types, periods, and/or any available control attributes selected.

FIG. 19B is an example screenshot illustrating another Commitment radar report, which may be built dynamically based on different attributes selected by a member, in this specific example “relationship type”, in accordance with an embodiment of the invention.

In this specific example, the Commitment Performer Alice 1902 selected the relationship type, which opens a corresponding menu 1950 to select the relationship type items to be displayed in the Radar Report.

In this specific Radar report 1992, Alice, as the Commitment Performer 1960, has higher Commitment rating in student to professor and daughter to mother relationship types, but higher quantity in the daughter to mother relationship type. At the same time, Alice has low Commitment rating in the worker to boss relationship type, besides the high Commitment Quantity.

FIG. 20 is an example screenshot illustrating a Commitment balance report, which may be built dynamically based on different attributes selected by a member, in this specific example “relationship category”, in accordance with an embodiment of the invention.

In one embodiment of the present invention, hitting the My Commitment reports 1140 quick access button followed by Balance button 2000 opens a Commitment balance attributes selector menu 2010, which presents the control attributes 2020 to be chosen 2030 as the balance based report info 2040. In this specific example, the Commitment Performer Alice 2002 selected the relationship category 2040, which opens the menu 2050 to select the relationship categories items to be displayed in a Commitment balance report 2060. Additionally the roles menu 2070 may be available to select the other members roles (Requestor and/or Evaluator), who are committed to the member in focus, and the roles menu 2074 may be also available to select the other members roles (Requestor and/or Evaluator), to whom the Member in focus is committed.

In one embodiment of the present invention, the Commitment balance report 2060 presents a data point for each selected item 2050 of the selected Commitment attribute 2040 with distance to the center proportional to the Commitment average rating, and the size of the dots proportional to the quantity of Commitments similar to radar report 1970. However in the balance based report there are two data points in the same horizontal line for each item selected 2080, one as the member in focus receiving the Commitment (left side) and another as the member in focus giving Commitment (right side). So it may be possible to measure the Commitment balance (receiving versus giving) among all selected relations.

In this specific Commitment balance report 2060, Alice, in the relationship category friends, has a good Commitment balance, however in the relationship category family, she has an unbalanced relationship because she is giving more Commitments in quantity and quality than receiving. In principle, this may not be a problem, but this type of visualization may be very interesting to identify potential ones.

FIG. 21 is an example screenshot illustrating a Commitment trend line based report, which may be built dynamically based on different attributes and metrics selected by a member, in accordance with an embodiment of the invention.

In one embodiment of the present invention, hitting the My Commitment reports 1140 quick access button followed by Trend lines button 2100 opens a Commitment trend lines attributes selector menu 2110, similar to other reports, which presents the control attributes 2120 to be chosen 2130 in a sequential navigation format 2140 in order to organize the Commitment navigation tree 2150 according to individual members preference. In this specific example, the Commitment Performer Alice selected the following Commitment control attribute sequence: \textcircled{1} roles and \textcircled{2} linked Commitment(s), which creates a Commitment tree 2150 with this sequence navigation organization 2160, specifically the Math Course Homework Commitments were selected 2164, resulting the trend line scope to be displayed in the Commitment trend lines graph report 2170.

Additionally, two different menus are available: the Select metric(s) menu 2180 (to select the metrics to be displayed in the Commitment trend lines graph report 2170) and the period menu 2190 (to select the time range under consideration).

In one embodiment of the present invention, the Commitment Trend lines Graph Report 2170 presents a data point for each selected metric 2180, within the selected Trend Line scope 2164 in the selected time period, which may comprise past available metrics and future “estimation” trend lines 2174 based on past metrics. These estimations can be done easily through standard mathematics trend lines equations.

In this specific trend line graph report 2170, Alice as Commitment Performer in the Math Course Homework Commitments has a natural trend to increase her Commitment ratings around 4 stars (⋆⋆⋆⋆) and quantity around 35 Commitments by 01Jan2017, based on her strong continuous improvement Commitment behavior in the last years.

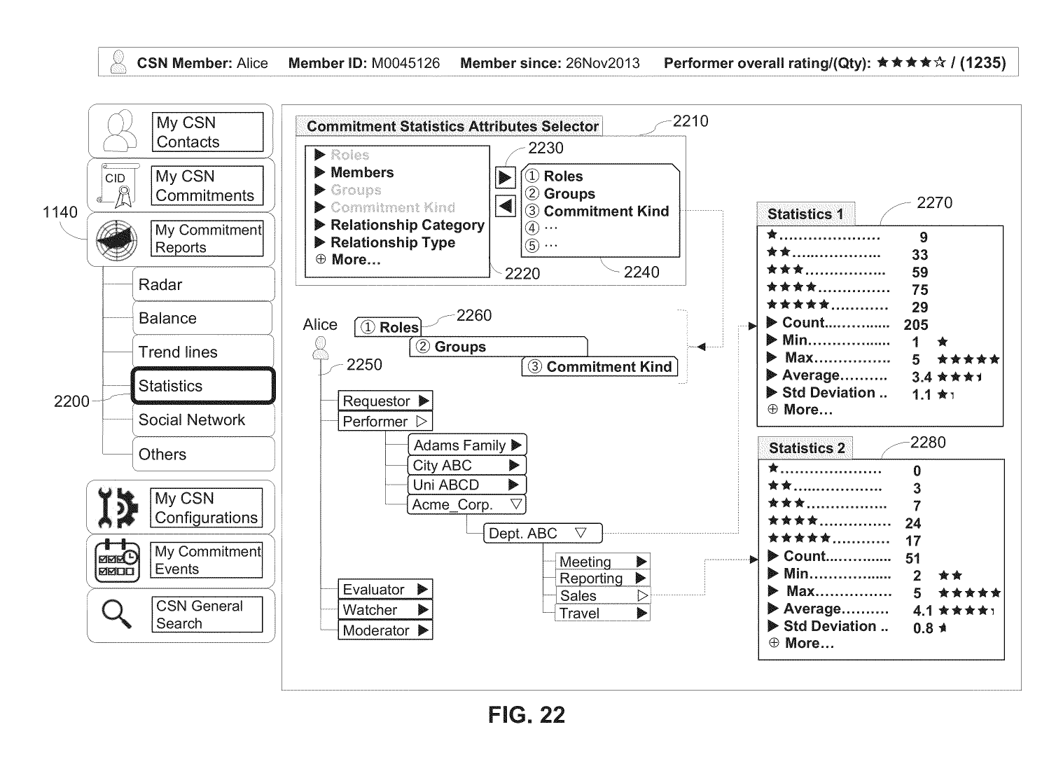

FIG. 22 is a screenshot example illustrating a Commitment statistic based report, which may be built dynamically based on selected Commitment attributes scope, in accordance with an embodiment of the invention.

In one embodiment of the present invention, hitting the My Commitment reports 1140 quick access button followed by Statistics button 2200 opens a Commitment statistic attributes selector menu 2210, which presents the control attributes 2220 to be chosen 2230 in a sequential navigation format 2240 in order to organize the Commitment navigation tree 2250 according to an individual member's preference. In this specific example, the Commitment Performer Alice selected the following control attribute sequence: \textcircled{1} roles, \textcircled{2} groups, and \textcircled{3} commitment kind, which creates a Commitment tree 2250 with this sequence navigation organization 2260 to be used to select the statistic scope to be displayed in the statistic reports 2270 and 2280.

In one embodiment of the present invention, the Commitment statistic report 2270 and 2280 may have a variety of statistics information in the selected scope, such as quantity of Commitments per each rating, count of Commitments, minimum and maximum rating, average rating, standard deviation, and any other useful statistic info.

In this specific example, Alice selected the Performer Role (first attribute: role) and group Acme_Corp+sub-group Dept_ABC (second attribute: group) as the scope for statistic report 1 2270, and a second scope within sub-group Dept_ABC, with sales as Commitment kind (third attribute: Commitment kind) for statistic report 2 2280. Based on the statistics results Alice has a better Commitment performance in Commitment kind sales than the other kinds.

FIG. 23 is an example screenshot illustrating a Commitment social network graph among a member in focus and other related members, which may be built dynamically based on selected attributes and deep levels, in accordance with an embodiment of the invention.

In one embodiment of the present invention, hitting the My Commitment reports 1140 quick access button followed by Social network button 2300 opens a Commitment social network attributes selector menu 2310, which presents the control attributes 2320 to be chosen 2330 as the scope of the graph 2340.

In this specific example, the relationship category 2340 was selected, which opens the menu 2350 to select the relationship category items to be displayed in the Commitment social network graph 2380.

Additionally, the Select levels deep menu 2360 may be available to select the number of network relations layers to be presented in the Commitment social network graph 2370.

In one embodiment of the present invention, the Commitment social network graph 2370 presents the member in focus in the center and other Commitment related members(s) connected by arrows according to the number of levels deep selected. The arrows may also contain the direction of the Commitment, that is, the arrow side points to the member receiving the Commitment 2380. Additionally the thickness of the arrows may be the quantity of Commitments in this relation 2390.

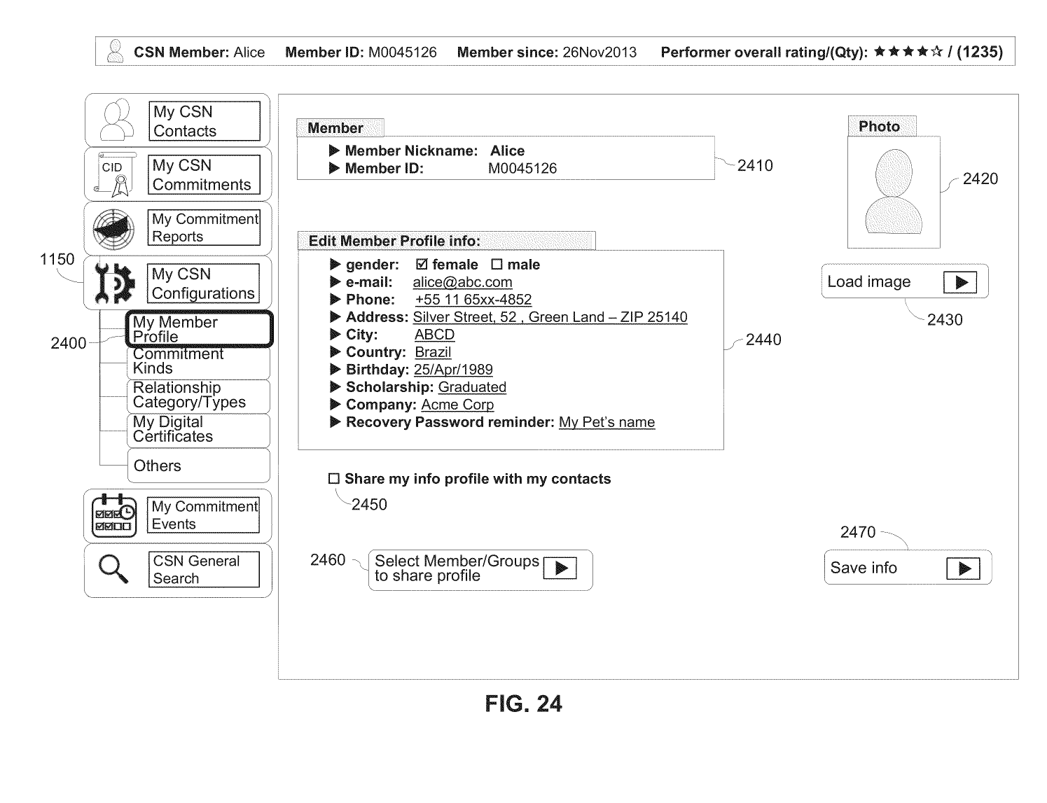

FIG. 24 is a screenshot example illustrating a member profile info and sharing configuration options, in accordance with an embodiment of the invention.

In one embodiment of the present invention, hitting the My CSN configurations 1150 quick access button followed by My member profile button 2400 opens a member profile, which may comprise: member menu 2410 with member nickname and ID, the member photo image 2420 and the load image button 2430, and the Edit member profile info menu 2440, which has a variety of info, such as gender, e-mail, phone, address, city, country, birthday, scholarship, company, recovery password reminder, and/or any useful information about a member profile.

Additionally, in order to increase privacy, there may be an option to share or not the member profile with other contacts 2450, which may be complemented with specific members and/or groups by hitting the Select member/groups to share profile button 2460. After editing the member profile info, it can be saved by hitting the save info button 2470.

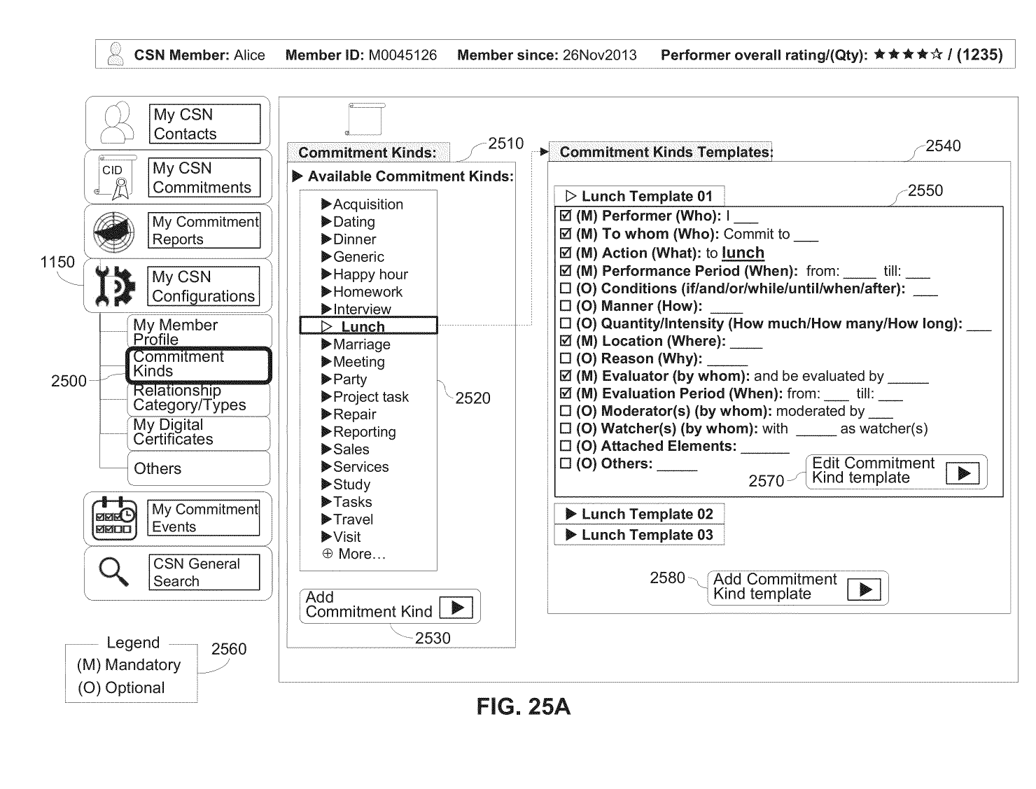

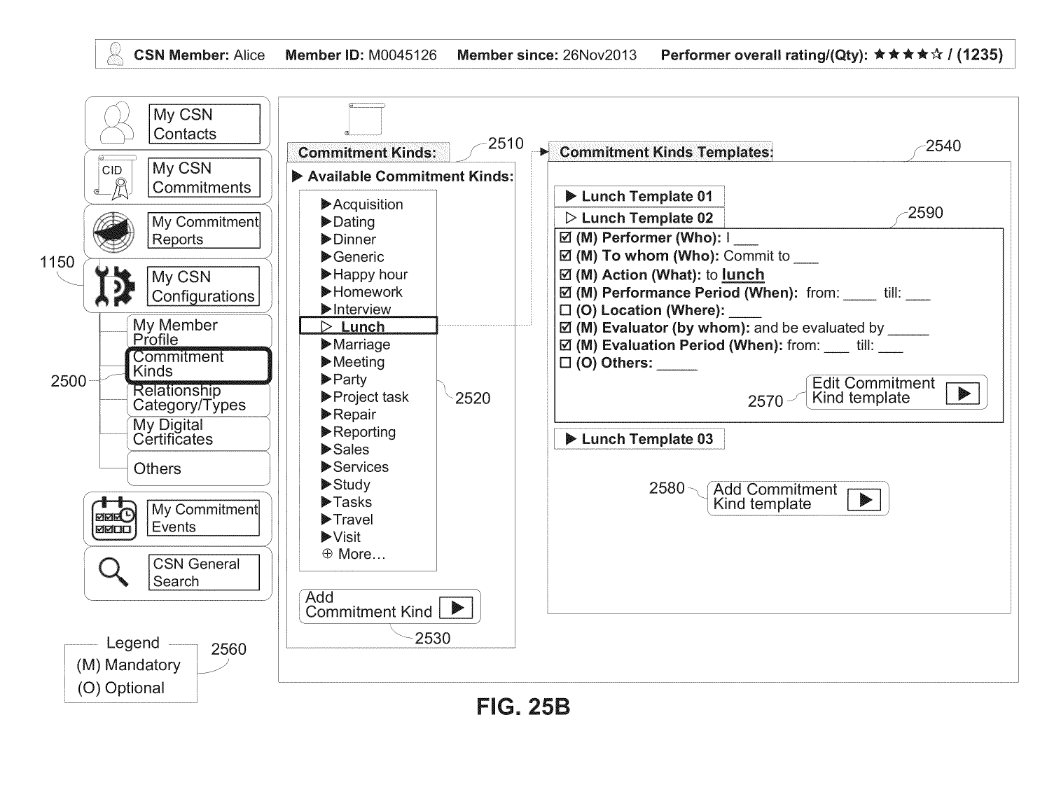

FIG. 25A is a screenshot example illustrating a configuration environment where a member may add/edit Commitment kinds and its respective templates, in accordance with an embodiment of the invention.

In one embodiment of the present invention, hitting the My CSN Configurations 1150 quick access button followed by Commitment kinds button 2500 opens a Commitment kinds configuration menu 2510, which has the standard available Commitment kinds 2520, plus an option to add new ones by hitting the Add Commitment kind button 2530. Selecting a specific Commitment kind opens a Commitment kinds templates menu 2540, which lists all available templates.

In this specific example, the Lunch_Template_{—}01 2550 was selected, which has several pre-defined (M) Mandatory or (O) Optional questions 2560, which may be used to elaborate the formal Commitment statement. In case of necessity to add, edit or even delete some of these questions, it is possible by hitting the Edit Commitment kind template button 2570. Another possibility may be to add another new template by hitting the Add Commitment kind template button 2580.

FIG. 25B is a screenshot example with another Commitment kind template, in accordance with an embodiment of the invention.

In this specific example, the Lunch_Template_{—}02 2590 was selected, which has fewer questions than Lunch_Template_{—}01 and, in particular, the location (Where) question has been changed from (M) Mandatory to (O) Optional, since it may be better used in less formal Commitments.

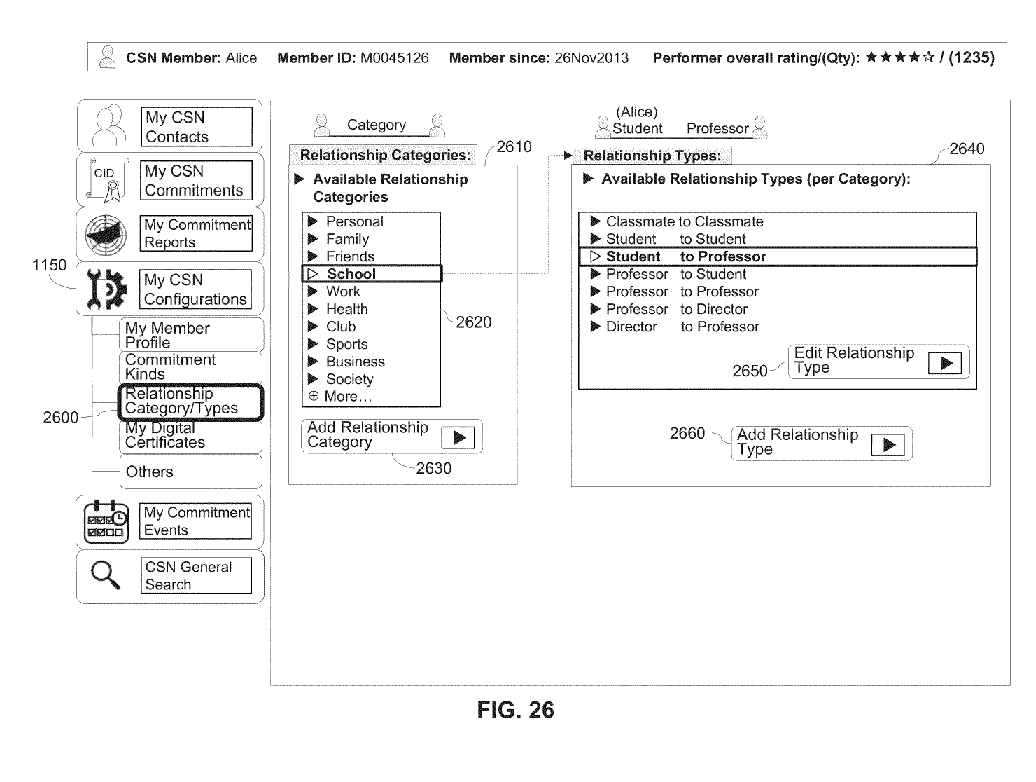

FIG. 26 is a screenshot example illustrating a configuration environment where a member may add/edit members relationship categories and relationship types, in accordance with an embodiment of the invention.

In one embodiment of the present invention, hitting the My CSN configurations 1150 quick access button followed by Relationship category/types button 2600 opens a relationship categories menu 2610, which has the standard available relationship categories 2620, plus an option to add new ones by hitting the Add relationship category button 2630. Relationship categories may relate to the social circles where they exist, such as personal, family, friends, neighborhood, school, work, business, club, sports, fitness, health, church, religion, politics, society, and/or a user-defined category. In an alternate embodiment of the present invention, relationship categories may relate to the relative social status, such as relationships with peers, relationships with superiors, and/or relationships with subordinates. Selecting a specific relationship category opens a relationship types menu 2640, which lists available types.

In this specific example, the school relationship category was selected and student to professor relationship type. In case of necessity to edit a relationship type, it is possible by hitting the Edit relationship type button 2650 and add a new one by hitting the Add relationship type button 2660.

In another embodiment, it may be possible that the same relationship type is used in different categories, such as friend to friend in categories friends and club.

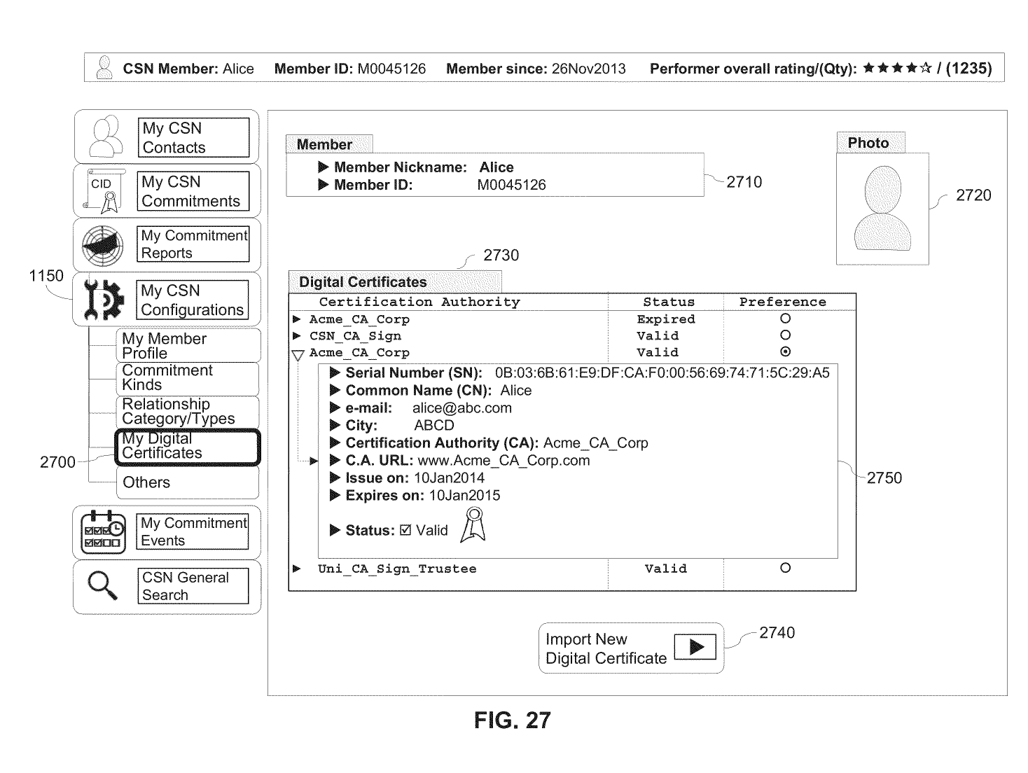

FIG. 27 is a screenshot example illustrating a configuration environment to manage a member digital certificate(s), in accordance with an embodiment of the invention.

In one embodiment of the present invention, hitting the My CSN Configurations 1150 quick access button followed by My digital certificates button 2700 opens a digital certification environment, which may comprise: member menu 2710 with member nickname and ID, the member photo image 2720, and the digital certificates menu 2730.

The digital certificate menu 2730 may comprise information regarding the digital certificates, which may be organized in columns, such as name of the Certification Authority, status of the digital certificate and a preference selector. It may be possible to import a new digital certificate by hitting the Import new digital certificate button 2740.

In this specific example, the Acme_CA_Corp digital certificate was selected, which has valid status and was also selected as the preferred one to be used in the next Commitment request.

In another embodiment, it may also be possible to list all available information regarding the digital certificate selected, such as Serial Number (SN), Common Name (CN), e-mail, city, Certification Authority (CA), CA URL, issue date, expiration date, status, and any other similar info 2750.

In another embodiment, it may also be possible to use an internal digital certificate, such as CSN_CA_Sign (shown in the second line of the Certification Authority column), in order to give an option for members who do not yet have a digital certificate to participate in the CSN 100.

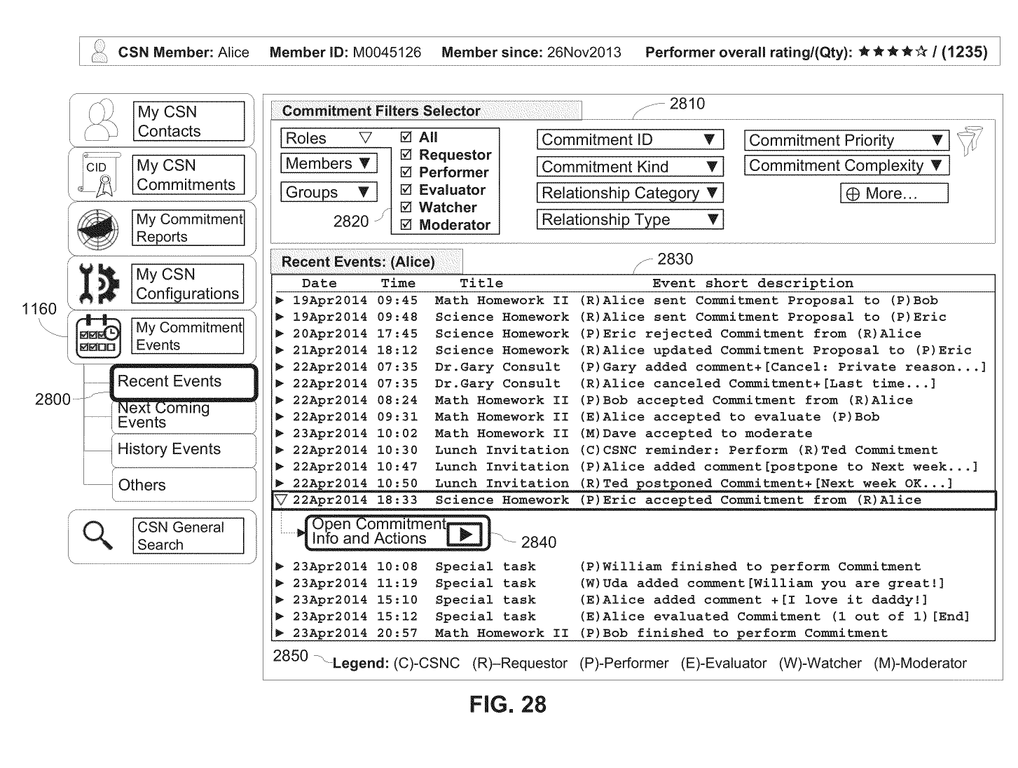

FIG. 28 is a screenshot example illustrating an environment to visualize and manage recent Commitment events, in accordance with an embodiment of the invention.

In one embodiment of the present invention, hitting the My Commitment Events 1160 quick access button followed by Recent Events button 2800 opens a Commitment filters selector menu 2810, which may comprise several Commitment control attributes used in logical combination to select and filter the scope of the Commitments displayed in the recent events menu 2830.

In this specific example, the roles control attribute was selected followed by selecting the first item [symbol] All, which automatically extended the selection to all other roles 2820.

The recent events menu 2830 shows the Commitment events which passed through the filter selections and may be organized in columns, such as event date, event time, Commitment title, and event short description.

Additionally, in the event description column one letter surrounded by parenthesis may be added to indicate the Role played by every member involved in the event, such as (R)-Requestor, (P)-Performer, (E)-Evaluator, (W)-Watcher, and (M)-Moderator 2850. The letter (C)-CSNC indicates events generated by CSNC like reminders, or any other similar.

In this specific example, the event dated in 22Apr2014 at 18:33 was selected with Science Homework title coming from member Eric as Commitment Performer 210 accepting to perform the certified Commitment proposal 410 by Alice as Commitment Requestor 200.

After the selection of the Commitment event it may be possible to open it in more detail by hitting the Open Commitment info and actions button 2840.

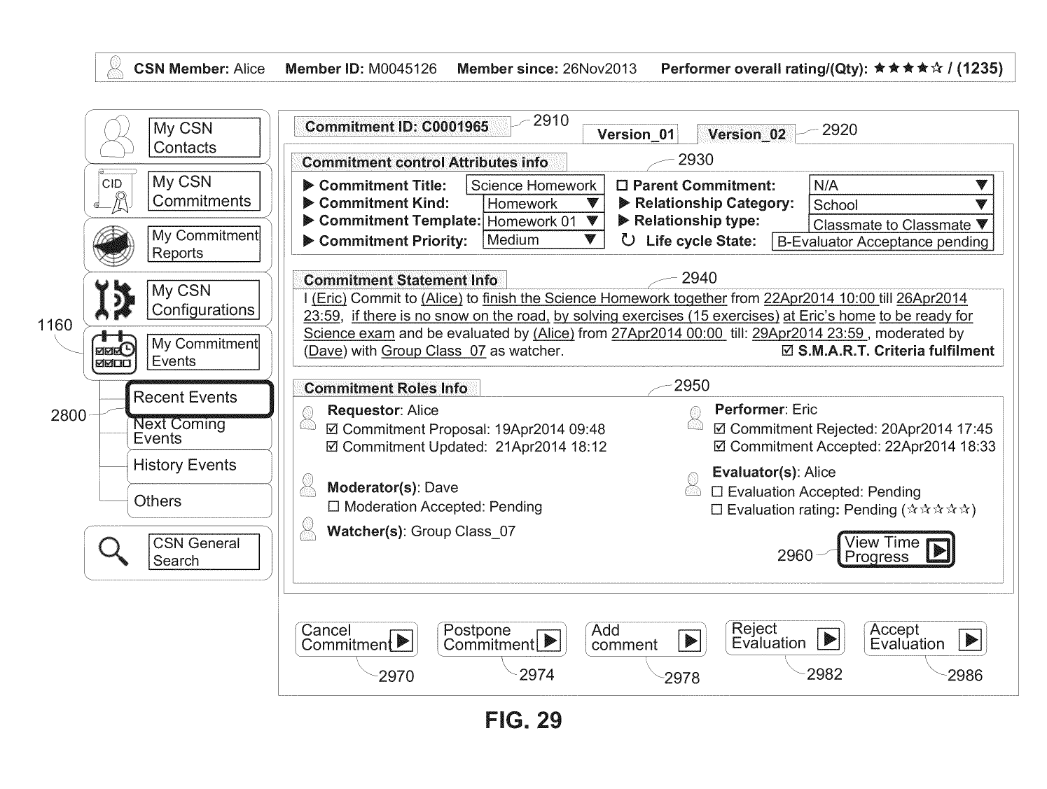

FIG. 29 is a screenshot example illustrating an environment to visualize and manage recent Commitment events in more details, such as Commitment ID, versions, attributes, roles assignments, and actions, in accordance with an embodiment of the invention.

After hitting the Open Commitment info and actions button 2840, the CSN opens an environment to manage the Commitment event which may comprise: Commitment ID 2910, Commitment version tabs 2920, Commitment control attributes info 2930, Commitment statement info 2940, Commitment roles info 2950, and action buttons 2970-2986.

The Commitment version tabs 2920 may be used to select different versions of the same Commitment, and are useful for managing evolutions and modifications. The Commitment control attributes info 2930 may comprise several control attributes to help in the Commitment management actions. The Commitment statement info 2940 shows the Commitment statement in detail, including the SMART criteria fulfilment. The Commitment roles info 2950 shows all the roles and member(s)/group(s) involved in this specific Commitment, including the main event dates related to each one. Additionally, it may also be possible to view these event dates in a time schedule format by hitting the View time progress button 2960.

Depending on the Commitment life cycle state and the member role, the action button(s) may be presented or not. In this specific case Alice is playing the role of Commitment Evaluator 220, which has the following action buttons: Add comment 2978, Reject evaluation 2982, and Accept evaluation 2986. Moreover, since Alice is also playing the role of Commitment Requestor 200 she also has the Cancel Commitment button 2970 and Postpone Commitment button 2974.

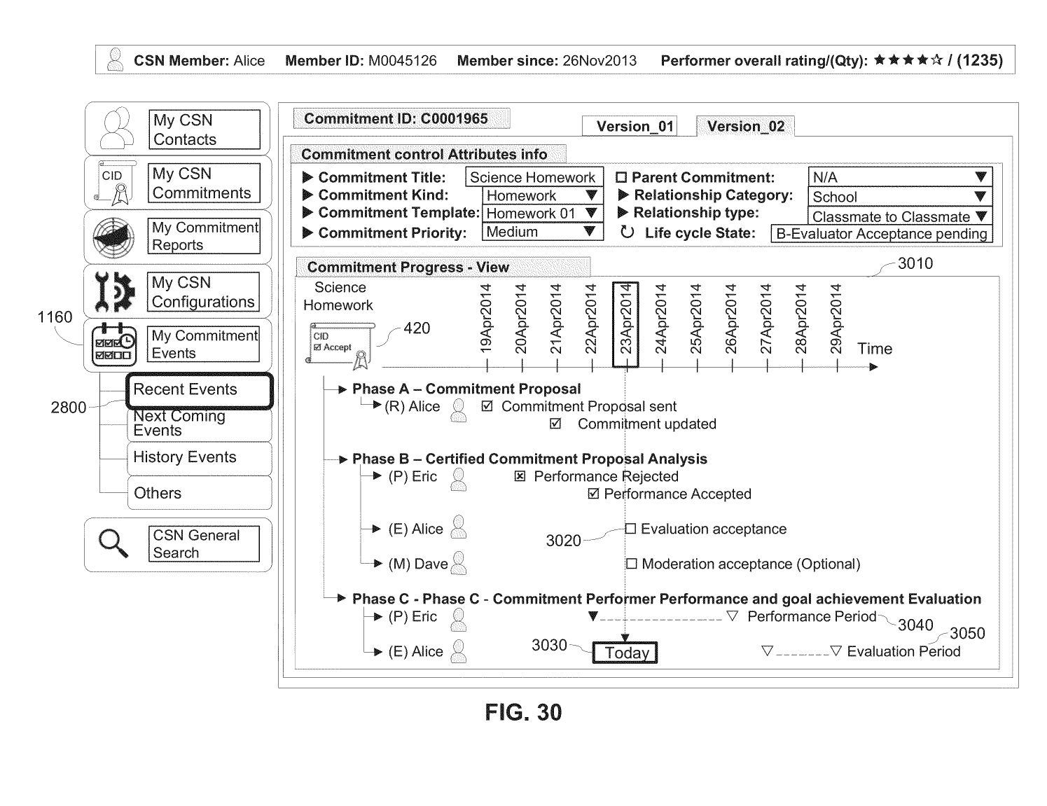

FIG. 30 is a screenshot example illustrating an environment to visualize recent Commitment events in a time schedule progress view, in accordance with an embodiment of the invention.

After hitting the View time progress button 2960, the CSN opens a Commitment progress view 3010, which shows the Commitment events in a time-schedule style by phases in order to provide a better view of the Commitment events on time.

In this specific example, it is possible to see the Commitment Requestor 200 (Alice) proposal sent on 19Apr2014, the Commitment Performer 210 (Eric) Performance rejection date on 20Apr2014, the Commitment Requestor 200 (Alice) proposal update on 21Apr2014, the Commitment Performer 210 (Eric) acceptance on 22Apr2014. On 23Apr2014 (today) 3030, the evaluation acceptance by Commitment Evaluator 220 (Alice) 3020 is pending. Additionally, it is also possible to visualize the performance period 3040 and the evaluation period 3050.

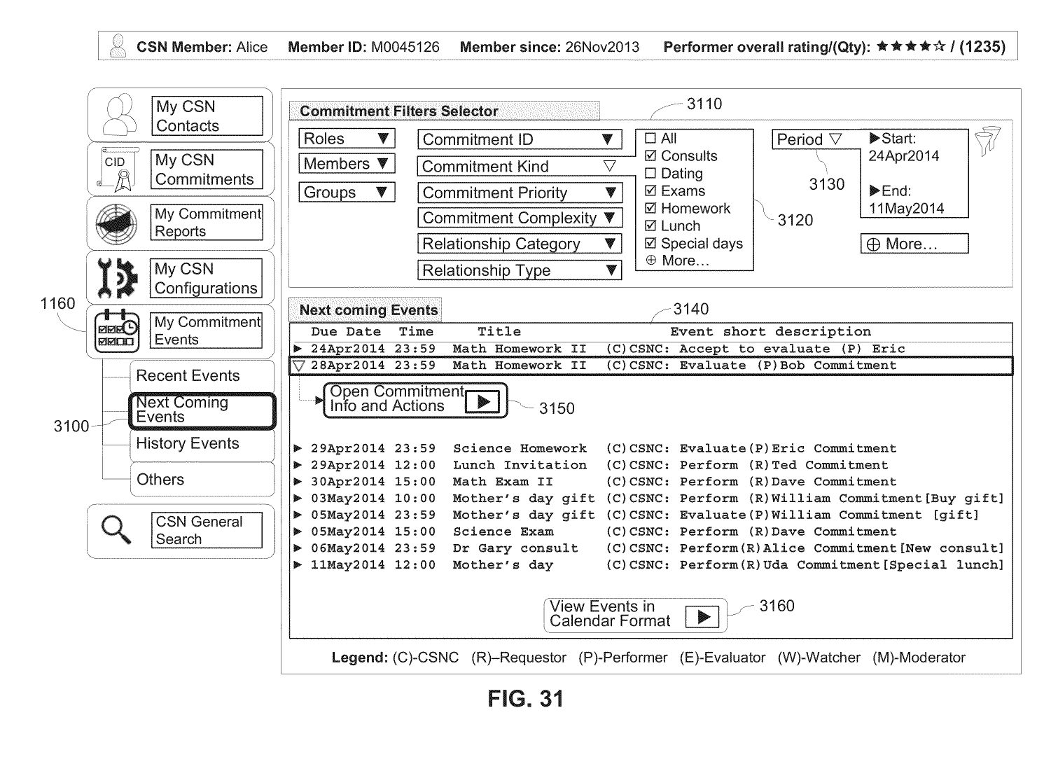

FIG. 31 is a screenshot example illustrating an environment to visualize and manage next coming Commitment events, in accordance with an embodiment of the invention.

In one embodiment of the present invention, hitting the My Commitment events 1160 quick access button followed by Next coming events button 3100 opens a Commitment filters selector menu 3110, which may comprise several Commitment control attributes used in logical combination to select and filter the scope of the Commitments displayed in the next coming events menu 3140.

In this specific example, the Commitment kind control attribute was selected followed by selecting a few items 3120. Additionally, a period filter 3120 was also selected, which may be combined with previous filter(s) to restrict the scope of the next coming events menu 3140.

The Next coming events menu 3140, may comprise future events, such as CSNC reminders to help CSN members to organize and plan their performance activities in order to reach good ratings and do not miss evaluations as well.

In this specific example, the next event dated on 28Apr2014 at 23:59 was selected with Math Homework II title, coming from CSNC reminding to evaluate (P) Bob Commitment.

After the selection of the next Commitment event it may be possible to open it in more details to take the appropriate actions by hitting the Open Commitment info and actions button 3150.

In another embodiment, it may be also possible to show the next coming events in a traditional calendar format 3160.

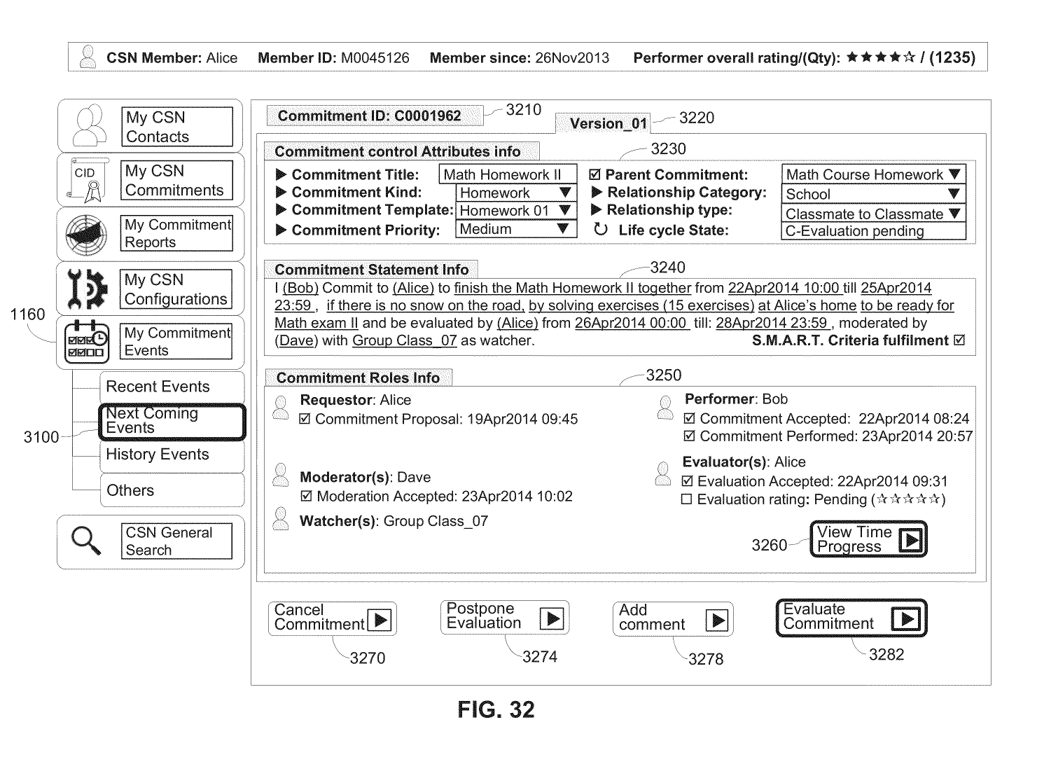

FIG. 32 is a screenshot example illustrating an environment to visualize and manage next coming Commitment events in more details, such as Commitment ID, versions, attributes, roles assignments, and actions, in accordance with an embodiment of the invention.

After hitting the Open Commitment info and actions button 3150, the CSN opens an environment to manage the next coming Commitment events, which shows the same items shown when managing recent Commitment events: Commitment ID 3210, Commitment version tabs 3220, Commitment control attributes info 3230, Commitment statement info 3240, Commitment roles info 3250, and action buttons 3270-3282.

Depending on the Commitment life cycle state and the member role, some action button(s) may or may not be presented. In this specific case Alice is playing the role of Commitment Evaluator 220, which has the following action buttons: Add comment 3278 and Evaluate Commitment 3282. Moreover, since Alice is also playing the role of Commitment Requestor 200 she also has the Cancel Commitment button 3270 and Postpone evaluation button 3274.

Similar to what is possible when managing recent Commitment events, it may also be possible to view the event dates in a time schedule format by hitting the View time progress button 3260.

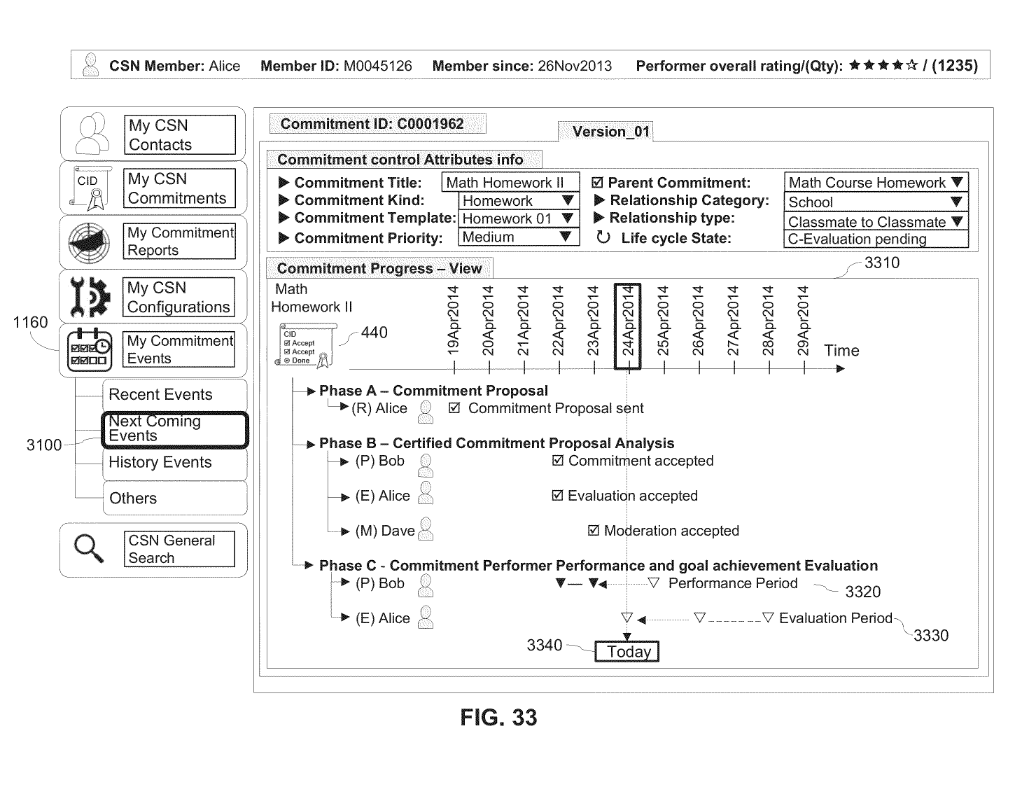

FIG. 33 is a screenshot example illustrating an environment to visualize next coming Commitment events in a time schedule progress view, in accordance with an embodiment of the invention.

After hitting the View time progress button 3260, the CSN opens a Commitment progress view 3310, which shows the Commitment events in a time-schedule style by phases in order to provide a better view of the Commitment events over time.

In this specific example, it is possible to see the Commitment Requestor 200 (Alice) proposal sent on 19Apr2014, the Commitment Performer 210 (Bob) acceptance on 22Apr2014, the Commitment Evaluator 220 (Alice) acceptance on 22Apr2014, the Commitment Moderator 240 (Dave) acceptance on 23Apr2014, and the Commitment Performer 210 (Bob) finished performance in 23Apr2014 before the Performance period due date 25Apr2014 3320. On 24Apr2014 (today) 3340, the Commitment evaluation period is already available to Commitment Evaluator 220 (Alice) because the Commitment done indication has already been done, however Alice has till 28Apr2014 to evaluate the Commitment 3330.

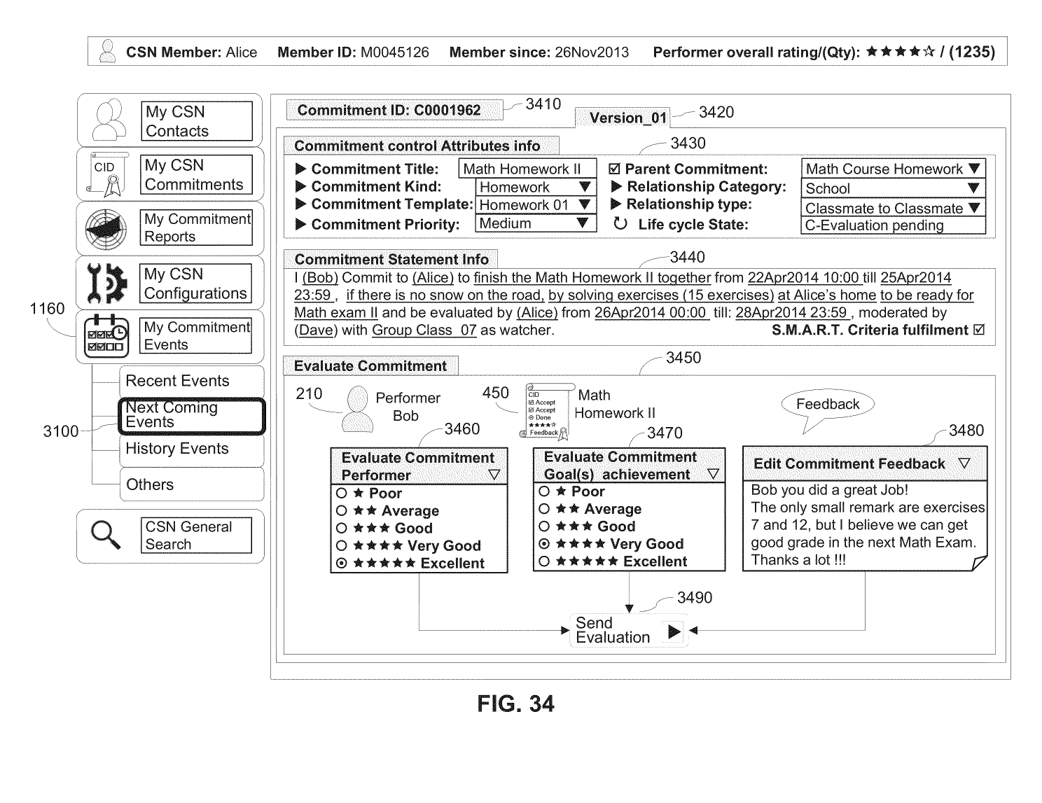

FIG. 34 is a screenshot example illustrating an environment to evaluate a Commitment, in accordance with an embodiment of the invention.

After hitting the Evaluate Commitment button 3282, the CSN opens a Commitment evaluation environment, which may comprise: Commitment ID 3410, Commitment version tabs 3420, Commitment control attributes info 3430, and Commitment statement info 3440 similar to previous screenshots plus the Evaluate Commitment menu 3450.

In one embodiment of the present invention, the Evaluate Commitment menu 3450 may comprise: evaluate Commitment Performer 3460 menu, evaluate Commitment goal(s) menu 3470, and edit Commitment feedback menu 3480.

The evaluate Commitment Performer menu 3460 may be used to evaluate the Commitment Performer 210 dedication and/or enthusiasm during the performance period related to the Commitment in focus. It may be rated using 5 stars grade, such as ⋆Poor, ⋆⋆Average, ⋆⋆⋆Good, ⋆⋆⋆⋆Very Good, ⋆⋆⋆⋆⋆Excellent, or any other rating scale, for instance 0 to 10, or even standard percentages.

The evaluate Commitment goal(s) achievement 3470 may be used to evaluate the Commitment goal(s) achievement regarding the Commitment statement info 3440. It may be rated similar to Commitment Performer, or use any other kind of rating.

The main difference of both evaluations, is that the first is oriented to the Performer, so it is more “emotional and warmer” and the second to the result(s), so it is more “logical and colder”.

Additionally, it may be possible to edit a Commitment feedback 3480, which may be used to provide general feedback comments, recommendations, lessons learned, and/or any continuous improvement stimulus to the Commitment Performer.

In this specific example, Alice as Commitment Evaluator 220, rated the Commitment Performer 210 Bob as ⋆⋆⋆⋆⋆Excellent, the Commitment goal(s) achievement as ⋆⋆⋆⋆Very Good, and send a Commitment feedback with small remarks of exercises 7 and 12. The Commitment evaluation may be sent by hitting the Send Evaluation button 3490.

In the context of CSN, it is highly advisable to not use the evaluation as punishment and/or discouragement by negative messages, but exactly the opposite and use it as a continuous improvement tool to help all involved members to reach a better Social Commitment Network with good balance among them. In case of not respectable feedback and abuse detection the member participation may be suspended or even canceled by a Commitment Moderator 240.

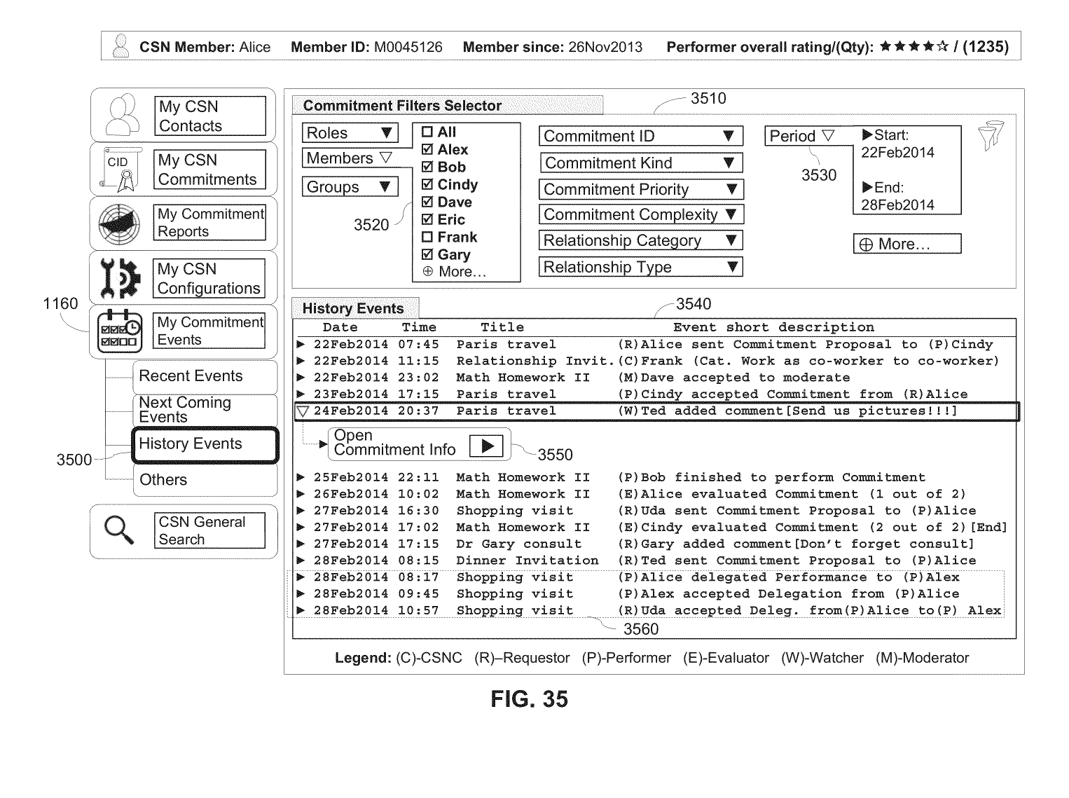

FIG. 35 is a screenshot example illustrating an environment to visualize and manage history Commitment events, in accordance with an embodiment of the invention.

In one embodiment of the present invention, hitting the My Commitment events 1160 quick access button followed by History events button 3500 opens a Commitment filters selector menu 3510, which may comprise several Commitment control attributes used in logical combination to select and filter the scope of the Commitments displayed in the History Events menu 3540.

In this specific example, the Commitment members control attribute was selected followed by selecting a few members 3520. Additionally a period filter 3530 was also selected which may be combined with previous filter(s) to restrict the scope of the history events 3540.

The history events menu 3540, may comprise past events, in order to enable the access of old information and/or to be used as reference for future Commitments.

In this specific example, the history event dated 24Feb2014 at 20:37 was selected, with Paris travel title, coming from Commitment Watcher 230 Ted as a comment, asking to send pictures about the travel.

After the selection of the history event it may be possible to open the Commitment in focus with more details, such as to see the attached elements, by hitting the Open Commitment info button 3550.

In another embodiment, it may also be possible to delegate Commitments to other members with the acceptance of the Commitment Requestor 200. In this specific example it is possible to follow a delegation sequence 3560: Alice as Commitment Performer 210 has delegated to her brother Alex to perform the shopping visit Commitment requested by her mother Uda as Commitment Requestor 200. Alex accepted the delegation, but the delegation process may be only concluded when the Commitment Requestor 200 Uda accepted the delegation as well.

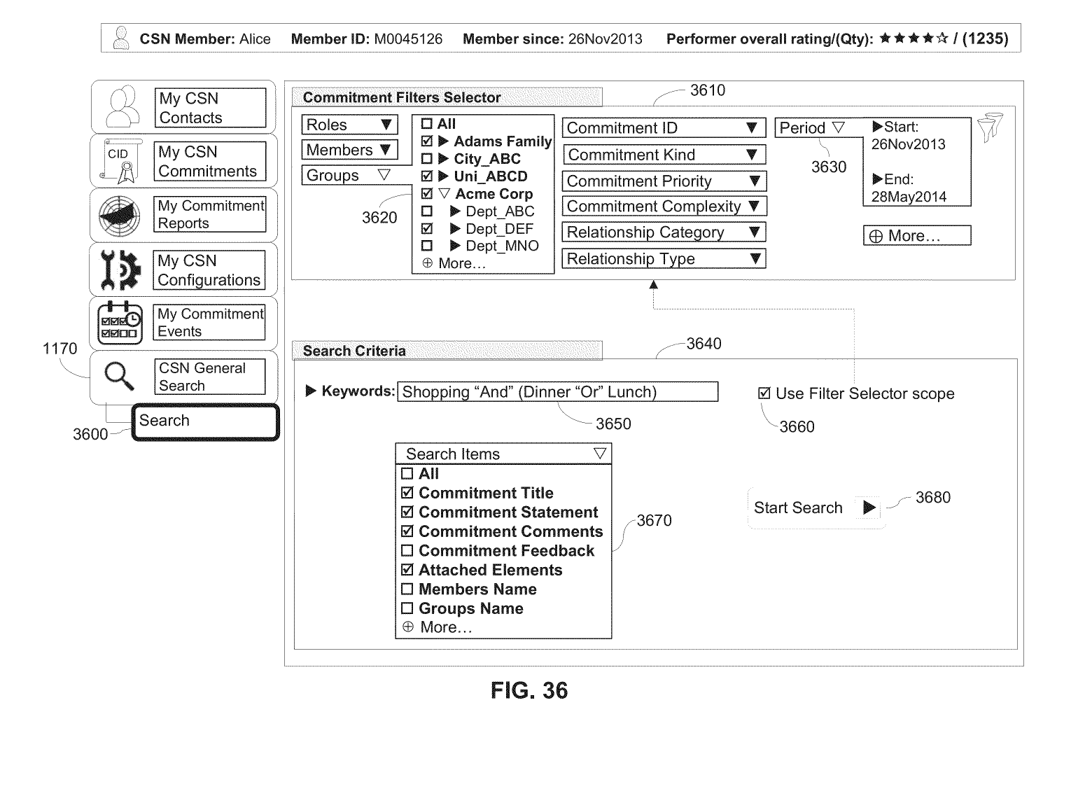

FIG. 36 is a screenshot example illustrating an environment to search CSN Commitment elements, in accordance with an embodiment of the invention.

In one embodiment of the present invention, hitting the CSN general search 1170 quick access button followed by Search button 3600 opens a Commitment filters selector menu 3610, which may comprise several Commitment control attributes used in logical combination to select and filter the scope of the Commitments displayed in the search.

In this specific example, the groups control attribute was selected followed by selecting some groups and sub-groups 3620. Additionally a period filter 3630 was also selected which may be combined with previous filter(s) to restrict the scope of the search.

The search criteria menu 3640 may comprise keywords under search 3650, filter selection scope option 3660, and search items 3670.

The keywords under search 3650 may be used to type the search element keyword(s), which may also include logical terms, such as operator “and”/“or” in the search engine. The Use filter selector scope option 3660 may be used to apply or not the filter(s) selected 3610 in the search. The search items menu 3670 may be used to select the type of items which the search will be applied. The search engine may be started by hitting the Start search button 3680.

### Alternative and Additional Embodiments

Furthermore, in other embodiments, it may also be possible to include the main principles and concepts of this Commitment Social Network (CSN) system and method invention in several different environments and formats, such as an Application Programming Interface (API), or web-based browser, or plug-in to be integrated in a project management application, a time-schedule application, an e-mail management application, and/or any kind of task management application, which may get the benefits to connect to the CSNC members database 150 and commitments database 160, and may use the available CSN resources in order to share, extend, and stimulate the commitment culture improvement among more members in different environments, but sharing the same commitment databases.

Even further, in other embodiments, it may also be possible to implement the main principles and concepts of this invention in a separate operating environment not necessarily connected to the CSNC members database 150 and commitments database 160, but to other databases belonging to other entities, such as a corporation, an enterprise, a school, a college, a university, a club, a church, a condominium, and/or even another existing Social Networks databases.

Moreover, in other embodiments, it may also be possible to include the main principles and concepts of this invention in circumstances where it may be necessary to relate several Commitments among several members and entities, such as supply chain, project management, contracts, open point lists, and/or any activity where several Commitments are inter-related with several types of dependencies to achieve a more abroad common goal.

Even more, in other embodiments, it may also be possible to include the main principles and concepts of this invention in special circumstances where the Commitments Evaluator(s) are volunteers in order to not restrict the evaluation only to Commitment Performer contacts and/or to not bother all members of a large group with evaluation invitations, therefore the Commitment Evaluator(s) are free to participate voluntarily. One example of this scenario may be the case of a politician making a Commitment promising something to a large member group, who may participate in the evaluation of the Commitment as volunteers.

Based on all the descriptions presented so far, it is possible to realize several advantages, innovations and large society benefits of this Commitment Social Network system and method invention.

1. A system for managing interactions in a network comprising:
a processor and a memory;
a communication network interface; and
a commitments control module;
wherein said processor and memory, said communication network interface, and said commitments control module are operably connected and are configured such that said commitments control module is enabled to:
receive profile information of one or more members;
receive a proposal to perform a commitment;
receive an acceptance to perform said commitment;
provide one or more members with information regarding the current status of said commitment;
receive a commitment done indication;
receive an evaluation of said commitment to produce an evaluated commitment; and
provide one or more members with information about said evaluated commitment.

2. The system of claim 1 further configured to receive comments on said commitment.

3. The system of claim 1 further configured to receive instructions relating to moderating conflicts, and/or, changing a commitment's deadline.

4. The system of claim 1 wherein said commitment is associated with a deadline defined by a commitment performance period and/or a commitment evaluation period.

5. The system of claim 1 further configured to verify that said commitment meets certain criteria by using a commitment template comprising:
a commitment role assignment field;
a field for a commitment statement;
a commitment's deadline field; and
a measurement field for defining a quantity or quality.

6. The system of claim 5 wherein said commitment template may be configured with additional fields in order to represent different commitment kinds.

7. The system of claim 1 further comprising an Access Control Module configured to verify the authenticity of members.

8. The system of claim 1 further comprising a Report Generator Module configured to use commitment data to generate at least one of:
a. A commitment radar report;
b. A commitment balance report;
c. A statistical report of commitment evaluations;
d. Commitment Trend lines; and
e. A network report showing one or more layers of commitment connections between members.

9. The system of claim 1 further configured to provide a commitment tree navigator wherein a user-definable hierarchy of commitment information categories defines the general structure of the commitment tree.

10. The system of claim 1 wherein said commitment may be assigned a unique identifier.

11. The system of claim 1 wherein relationships between members may be categorized into two or more relationship categories.

12. The system of claim 11 wherein said relationship categories comprise: personal, family, friends, neighborhood, school, work, business, club, sports, fitness, health, church, religion, politics, society, and/or a user-defined category.

13. The system of claim 11 wherein said relationship categories comprise:
relationships with peers, relationships with superiors, and/or relationships with subordinates.

14. The system of claim 11 wherein relationships within a relationship category may be further defined by relationship types related to the roles of one or more members in the relationship.

15. The system of claim 14 wherein said roles comprise: child, parent, brother, sister, friend, boyfriend, girlfriend, husband, wife, classmate, student, professor, patient, doctor, peers, coworker, boss, employee, employer, subordinate, superior, supplier, client, and/or a user-defined role.

16. The system of claim 1 wherein said commitments may depend upon and/or be linked to one or more other commitments.

17. A method of managing interactions in a network comprising the steps of:
receiving profile information of one or more members;
receiving a proposal to perform a commitment;
receiving an acceptance to perform said commitment;
providing one or more members with information regarding the current status of said commitment;
receiving a commitment done indication;
receiving an evaluation of said commitment to produce an evaluated commitment; and
providing one or more members with information about said evaluated commitment.

18. The method of claim 17 further comprising the step of receiving comments on said commitment.

19. The method of claim 17 further comprising the step of receiving instructions relating to moderating conflicts, and/or, changing a commitment's deadline.

20. The method of claim 17 wherein said commitment is associated with a deadline defined by a commitment performance period and/or a commitment evaluation period.

21. The method of claim 17 further comprising the step of verifying that said commitment meets certain criteria by using a template comprising:
a commitment role assignment field;
a field for a commitment statement;
a commitment's deadline field; and
a measurement field for defining a quantity or quality.

22. The method of claim 21 wherein said commitment template may be configured with additional fields in order to represent different commitment kinds.

23. The method of claim 17 further comprising the step of verifying the authenticity of members.

24. The method of claim 17 further comprising the step of using commitment data to generate at least one of:
a. A commitment radar report;
b. A commitment balance report;
c. A statistical report of commitment evaluations;
d. Commitment Trend lines; and
e. A network report showing one or more layers of commitment connections between members.

25. The method of claim 17 further comprising the step of providing a commitment tree navigator wherein a user-definable hierarchy of commitment information categories defines the general structure of the commitment tree.

26. The method of claim 17 further comprising the step of assigning said commitment a unique identifier.

27. The method of claim 17 further comprising the step of categorizing relationships into two or more relationship categories.

28. The method of claim 27 wherein said relationship categories comprise:
personal, family, friends, neighborhood, school, work, business, club, sports, fitness, health, church, religion, politics, society, and/or a user-defined category.

29. The method of claim 27 wherein said relationship categories comprise:
relationships with peers, relationships with superiors, and/or relationships with subordinates.

30. The method of claim 27 further comprising the step of defining relationships within a relationship category by relationship types related to the roles of one or more members in the relationship.

31. The method of claim 30 wherein said roles comprise: child, parent, brother, sister, friend, boyfriend, girlfriend, husband, wife, classmate, student, professor, patient, doctor, peers, coworker, boss, employee, employer, subordinate, superior, supplier, client, and/or a user-defined role.

32. The method of claim 17 wherein said commitments may depend upon and/or be linked to one or more other commitments.

33. The system of claim 7 wherein said Access Control Module verifies the authenticity of members through digital certificates.

34. The method of claim 23 wherein authenticity of members is verified using digital certificates.
